(19) United States
(12) Patent Application Publication
(10) Pub. No.: US 2003/0105710 A1
(43) Pub. Date: Jun. 5, 2003

(54) Method and system for on-line payments

(76) Inventors: Ellen Barbara, Bedford, NY (US); Antony Jenkins, New York, NY (US)

Correspondence Address: KILPATRICK STOCKTON LLP, 607 14TH STREET, N.W., SUITE 900, WASHINGTON, DC, 20005, US

(21) Appl. No.: 10/234,609

(22) Filed: Sep. 4, 2002

Related U.S. Application Data
(63) Continuation-in-part of application No. 09/903,284, filed on Jul. 11, 2001.
(60) Provisional application No. 60/217,489, filed on Jul. 11, 2000.
(60) Provisional application No. 60/219,088, filed on Jul. 18, 2000.
(60) Provisional application No. 60/316,993, filed on Sep. 4, 2001.

(51) Int. Cl. G06F 17/60

(52) U.S. Cl. 705/39; 705/44

(57) ABSTRACT

A method and system for making on-line payments makes use of computer hardware and software and utilizes, for example, a payment engine that facilitates the making of payments via the Internet. A user enrolls for the on-line payments service, designates a source account for the on-line payments, and is provided a transaction account as a money deposit account with an account number that the user can use as a source and a destination of funds and with one or more service levels. The user can make, for example, on-line payments, on-line and/or off-line purchases, cash withdrawals at an ATM, credit card account payments, bill payments, and/or international payments with funds in the transaction account and/or a line of credit associated with the transaction account. A quick enrollment aspect of the on-line payments services pre-qualifies the customers of a third party on-line service provider, such as an ISP, for the service. A funds transfer capability aspect provides, for example, an instant availability of funds for the customer.

### PRIORITY APPLICATION

This application claims the benefit of U.S. Provisional Application No. 60/316,993 filed Sep. 4, 2001, entitled “Method and System for On-Line Payments,” which is incorporated herein by this reference.

This application is a continuation-in-part of co-pending U.S. Patent application Ser. No. 09/903,284 filed Jul. 11, 2001, entitled “Method and System for On-Line Payments,” which claims the benefit of U.S. Provisional Application No. 60/217,489 filed Jul. 11, 2000, entitled “Method and System for On-Line Person-to-Person Payments (Person-to-Person Functionality),” and U.S. Provisional Application No. 60/219,088 filed Jul. 18, 2000, entitled “Method and System for On-Line Person-to-person Payments (Person-to-Person Functionality),” each of which is incorporated herein by this reference.

### CROSS REFERENCE TO RELATED APPLICATIONS

This application relates to U.S. Utility Application No. 09/610,540 filed Jul. 7, 2000, entitled “Method and System for Managing and Conducting a Network Auction and U.S. Provisional Application No. 60/143,021 filed Jul. 9, 1999, entitled “Method and System for Managing and Conducting a Network Auction,” which are incorporated herein by this reference.

### FIELD OF THE INVENTION

The present invention relates generally to the field of electronic commerce and more particularly to a method and system for making on-line payments utilizing a transaction account as a hub for such payments.

### BACKGROUND OF THE INVENTION

Currently, on-line consumers have limited ability to facilitate payments between two individuals other than by an individual check by mail, which is the present paying paradigm. So, for example, in the on-line auction context, payments are actually being made person-to-person via check or money order. It takes an inordinate amount of time to clear checks through the current Automated Clearing House (ACH) systems, which slows down the purchasing process considerably via the on-line auction context. In addition, there is a need for consumers to be able to facilitate person-to-person payments, for example, to facilitate birthday presents or reimbursement of funds that were spent without a merchant being involved that eliminates the necessity for consumers to use paper checks or cash as the payment vehicle between two individual parties. Presently, there is a focus of efforts on promotion of person-to-person payments, for example, through on-line auction web sites in which person-to-person payment providers are very focused on the facilitation of payments between two individuals. However, such efforts do not include other payment mechanisms, such as bill payments, on-line and off-line purchases, cash withdrawals, credit card account payments, and/or international payments.

### SUMMARY OF THE INVENTION

It is a feature and advantage of the present invention to provide a method and system for on-line payments which enables the making of payments using any of a credit card or a checking account or savings account to facilitate an on-line transaction.

It is another feature and advantage of the present invention to provide a method and system for on-line payments which enables a user to view all of a user's financial information in one space using aggregating technology.

It is an additional feature and advantage of the present invention to provide a method and system for on-line payments that enables a user to facilitate the payment of bills and the presentment of the user's bills via the Internet.

It is a further feature and advantage of the present invention to provide a method and system for on-line payments that gives users a single place to go to be able to transact all of their payments, such as payments to merchants and/or individuals.

It is a still further feature and advantage of the present invention to provide a method and system for on-line payments which utilizes a transaction account as a hub, which is a repository for the flow of funds into and out of the account, that enables a customer to have funds reside in the transaction account and to transmit funds from that account to others.

It is another feature and advantage of the present invention to provide a method and system for on-line payments, which allows a user to designate a credit card account or a deposit account as a source account for withdrawing funds for the on-line payments.

It is a further feature and advantage of the present invention to provide a method and system for on-line payments utilizing a transaction account, which functions as a money deposit account with an account number, that the user can use as a source and a destination of funds and with one or more service levels.

It is another feature and advantage of the present invention to provide a method and system for on-line payments that enables the transfer of funds between accounts regardless of the financial institution.

It is an additional feature and advantage of the present invention to provide a method and system for on-line payments that also enables the user to make on-line and off-line purchases, to withdraw cash, to make bill payments, and to make international payments with funds in the transaction account.

It is a further feature and advantage of the present invention to provide a method and system for performing an on-line transaction that employs a quick enrollment process.

It is another feature and advantage of the present invention to provide a method and system for performing an on-line transaction that utilizes a funds transfer capability, for example, to provided an instant availability of funds.

It is an additional feature and advantage of the present invention to provide a method and system for performing an on-line transaction that employs a distribution method for the on-line service of the invention with a third party as a distributor of the product.

To achieve the stated and other features, advantages and objects, an embodiment of the present invention makes use of computer hardware and software and utilizes, for example, a payment engine that facilitates the making of payments via the Internet. The present invention enables the making of such payments between individuals using their credit cards, checking accounts and/or savings accounts to facilitate an on-line person-to-person transaction. Another aspect of the present invention enables a user to view all of the user's financial information in one space using aggregating technology. Additional aspects of the present invention enable a user to facilitate making on-line and off-line purchases, withdrawing cash, making bill payments, and making international payments via the Internet. The present invention leverages the customer service facilities of a financial institution, such as the financial institution's bank cards organization to handle 24×7 live person customer service and secure on-line customer service.

In an enrollment aspect of the on-line payment method and system for an embodiment of the present invention, enrollment information is received by the system from a user via an enrollment page for the on-line payments service. The information is received from the user in response to prompts and includes, for example, information about the user necessary to fulfill a “know your customer” (KYC) obligation of a financial institution as a provider of the on-line payments service and to enable the financial institution to validate that the user is bona fide. The information received from the user in response to such prompts is also relevant in settling disputes related to use of the on-line payments service by the user.

In response to further prompts by the system for an embodiment of the present invention, the user designates a source account for use in the on-line payments service from which funds can be withdrawn, for example, to make on-line payments. The source account designated by the user can be, for example, a credit card account and/or a deposit account of the user. If a credit card account is designated, the user is prompted to enter information about the credit card account, such as a credit card number, a credit card expiration date, and/or a credit card verifier. The system retains that information as it does not have to be entered again. The system performs a back end authorization to confirm that the received information relates to a valid credit card account of the user, and the user is ready to transact via the on-line payments service.

If a deposit account, such as checking account, a debit account, and/or a money market account of the user, is designated as the source account, the user is prompted to enter information about the deposit account, such as a deposit account number and/or an American Bankers Association (ABA) number of a financial institution with which the deposit account is maintained. The system likewise performs a back end validation to confirm that the user is the owner of the designated deposit account, and the user is likewise ready to transact via the on-line payments service.

In the on-line payments system and method for an embodiment of the present invention, the enrolled user is provided a transaction account, which functions as a money deposit account with an account number, that the user can use as a source and a destination of funds and with one or more service levels. The transaction account service levels include, for example, a first or basic service level that provides a person-to-person payment service enabling the user to receive and send funds from the user's transaction account. At the first or basic service level, the transaction account includes a save for later feature that enables the user to accumulate a balance of funds in the user's transaction account for later use. In addition, the transaction account at the first or basic service level includes a held money feature for retaining funds in the user's transaction account which the user has designated to be sent to a recipient but which have not yet been picked up by the recipient.

The transaction account service levels also include, for example, a second or premium service level that provides all the features of the first level of service plus an access card that enables the user to access funds in the user's transaction account for off-line transactions. In addition, the transaction account service levels also include, for example, a third or ultimate service level that provides all the features of the first and second levels of service plus a credit line that enables the user to access both line of credit funds and accumulated balance funds in the user's transaction account. In addition, the access card that is provided in connection with the second and third levels of service allows the user to withdraw funds from the transaction account, for example, at a self-service financial transaction terminal, such as an automatic teller machine (ATM).

The user is allowed to have funds reside in the transaction account for an embodiment of the present invention and to utilize the transaction account as a hub for user transactions. For example, the user can use the trust account for receiving person-to-person payments, and the user can fund the transaction account with funds withdrawn from the designated source account, such as the designated credit card account or one or more of the designated deposit accounts of the user. The funds residing in the user's transaction account are held, for example, in a save for later portion of the account for accumulating funds and/or a held money portion of the transaction account for funds designated by the user for a payment which has not been picked up by the recipient, and the user can view balances of both portions from time to time.

In the on-line payment method and system for an embodiment of the present invention, the user can use the funds residing in the transaction account, for example, for making on-line payments, on-line purchases, off-line purchases, cash withdrawals, credit card account payments, bill payments, and/or international payments with funds in the transaction account. For an on-line payment, for example, funds in the transaction account are designated for the on-line payment to a recipient according to an instruction by the user. The user can make an on-line purchase, for example, by authorizing payment to an on-line merchant for an on-line transaction by furnishing the on-line merchant the transaction account number. The user can also make an off-line purchase by authorizing payment to an off-line bricks and mortar merchant using a transaction card provided to the user in connection with the transaction account. Alternatively, the user can withdraw funds in cash from the transaction account at a self-service financial transaction terminal with the transaction card.

Further, the user can use the funds in the transaction account for making a credit card account payment by authorizing the payment to the user's credit card account, for making a bill payment through a bill payment service, and/or for making an international payment through an international payment service. The user can use the save for later portion of the funds in the transaction account for any of such transactions, or if the user qualifies for and requests a line of credit in connection with the transaction account, the user can supplement the save for later portion with the line of credit for such transactions.

In a quick enrollment aspect of an embodiment of the present invention, utilizing computer hardware and software, a financial institution that provides the on-line payments service arranges pre-qualification of customers of a third party on-line service provider, such as an Internet Service Provider, for an on-line payments service based on pre-defined parameters established by the financial institution, and the third party service provider executes the pre-qualification based on the pre-defined parameters. One of the pre-defined parameters for pre-qualification is that the customers of the third party service provider must pay the service provider's charges using a credit card account. In connection with a third party integration feature of the quick enrollment aspect, the on-line payments service can co-branded by the third party service provider, such as the Internet Service Provider, and the financial institution.

In the quick enrollment aspect, the financial institution receives customer information about one or more pre-qualified customers from the third party service provider pursuant to an indication of agreement entered by the customer at a terminal in response to a prompt. However, the customer information is sent to or shared with the financial institution by the third party service provider only after entry by the customer at the terminal in response to a prompt of an indication of the customer's agreement to allow the third party service provider to share the customer information with the financial institution. The customer information is received in the form of pre-defined customer information fields for the customer in response to a request by the financial institution.

Additionally, in the quick enrollment aspect, the customer at the terminal is allowed in response to a prompt to confirm the customer information on a review information page pre-filled with the customer information received from the third party service provider. In this regard, the customer is allowed to confirm and update the pre-filled customer information consisting wholly or partly of the customer's name, address, and telephone number received from the third party service provider. Thereafter, the customer at the terminal is allowed in response to a prompt to enter information, for example, on an account security page, that specifically pertains to a proposed transaction account for the customer and for thereafter accessing the account, such as a transaction account password and an indication of the customer's consent relative to an electronic signature.

Further, in the quick enrollment aspect, the customer is prompted for entry of the customer's indication of the customer's acceptance of terms, conditions, and legal notifications pertaining to the proposed transaction account, and a jump page is displayed for the customer at the terminal with information, such as a conditional approval of the proposed transaction account and instructions pertaining to linking a source account. At this point, the proposed transaction account is conditionally approved for the customer by the financial institution without further verification and with a pre-defined service level and subject to a pre-determined transaction threshold. The conditional approval includes, however, employing a customer relations management process to request the customer's Social Security Number and date of birth if the pre-determined transaction threshold is reached. Once the transaction account is conditionally approved for the customer, the customer is allowed to use the account for transactions according to pre-determined transaction parameters established for the pre-defined service level and subject to the pre-determined transaction threshold. If and when the pre-determined transaction threshold is reached, an outbound email message is generated to the customer by a fraud early warning process requesting the customer's Social Security Number and date of birth.

A funds transfer capability aspect of an embodiment of the present invention allows a customer at a terminal to use the customer's transaction account to transfer funds, for example, between eligible accounts. In this aspect, the customer is prompted to enter an amount and a selection of an eligible “transfer from” account and an eligible “transfer to” account from a drop down box on a transfer cash page. Thereafter, the customer is prompted to confirm the customer's entry of the amount and selection of the transfer from and transfer to accounts on a confirm page. In addition, the customer can use the transaction account to transfer funds, for example, via selection of a self-fund mechanism. If the self-fund selection is made for the customer without an account enrolled as a source account, the customer is prompted to enroll a source of funds account. If the customer enrolls a credit card account verified as the customer's account as the source account, the customer is provided an instant availability of funds.

Additional objects, advantages and novel features of the invention will be set forth in part in the description which follows, and in part will become more apparent to those skilled in the art upon examination of the following, or may be learned by practice of the invention.

### BRIEF DESCRIPTION OF THE DRAWINGS

FIG. 1 is a schematic flow diagram that illustrates an overview of an example of key components and the flow of information between key components for a person-to-person payment aspect of an embodiment of the present invention;

FIG. 2 is a flow chart which shows an example of the enrollment process for the person-to-person payment aspect of an embodiment of the present invention;

FIG. 3 is a flow chart which illustrates an example of the person-to-person payment process for an embodiment of the present invention;

FIG. 4 is a flow chart which shows an example of the process of receiving a person-to-person payment for an embodiment of the present invention;

FIG. 5 is a table which illustrates examples of uses of funds in the transaction account for an embodiment of the present invention;

FIG. 6 is a schematic diagram that illustrates an example of properties of the “all account” at the basic or silver level of service for an embodiment of the present invention;

FIG. 7 is a schematic diagram that illustrates an example of properties of the “all account” at the premium or gold level of service for an embodiment of the present invention;

FIG. 8 is a schematic diagram that illustrates an example of properties of the “all account” at the ultimate or platinum level of service for an embodiment of the present invention;

FIG. 9 is a schematic diagram which illustrates an example overview of key components and the flow of information between the key components of the international payments aspect of an embodiment of the present invention;

FIG. 10 shows a sample user interface screen for an international check payment aspect of an embodiment of the present invention;

FIG. 11 shows a sample user interface screen for an international wire payment aspect of an embodiment of the present invention;

FIG. 12 shows a sample user interface screen for an international ACH payment aspect of an embodiment of the present invention;

FIG. 13 is a flow chart which illustrates an example of the process of initiating an international payment on the system for an embodiment of the present invention;

FIGS. 14 and 14a is a schematic flow chart which illustrates an example of the enrollment module for an embodiment of the present invention;

FIG. 15 is a schematic flow chart which illustrates an example of the log in process for an embodiment of the present invention.

FIG. 16 is a schematic flow chart which illustrates an example of the pick up/request cash module for an embodiment of the present invention;

FIG. 17 is a schematic flow chart which illustrates an example of the send cash module for an embodiment of the present invention;

FIGS. 18 and 19 are schematic flow charts which illustrate examples of the transfer and self fund module for an embodiment of the present invention;

FIG. 20 is a schematic flow chart which illustrates an example of the cancel transaction module for an embodiment of the present invention;

FIG. 21 is a schematic flow chart which illustrates an example of the add account module for an embodiment of the present invention;

FIG. 22 is a schematic flow chart which illustrates an example of the edit account module for an embodiment of the present invention;

FIG. 23 is a schematic flow chart which illustrates an example of the delete account module for an embodiment of the present invention;

FIG. 24 is a schematic flow chart which illustrates an example of the history/statement module for an embodiment of the present invention;

FIG. 25 is a schematic flow chart which illustrates an example of the profile update module for an embodiment of the present invention;

FIG. 26 is a table which illustrates an example of the GUI screen flow order for the quick enrollment aspect of an embodiment of the present invention;

FIG. 27 is a table which illustrates an example of a use case for the process of reviewing membership information in the quick enrollment process for an embodiment of the present invention;

FIG. 28 is a table which illustrates an example of a use case for the process of setting up account security in the quick enrollment process for an embodiment of the present invention;

FIG. 29 is a table which illustrates an example of a use case for the process of accepting terms and conditions in the quick enrollment process for an embodiment of the present invention;

FIG. 30 a table which illustrates an example of a use case for a welcome/conditional/jump page in the quick enrollment process for an embodiment of the present invention;

FIG. 31 is a flow chart which illustrates an example of use of a transfer module for the process of moving funds between registered accounts for an embodiment of the present invention;

FIG. 32 is a flow chart which shows an example of the process of transferring funds in the system for an embodiment of the present invention; and

FIGS. 33-35 are sample GUI screens for the process of transferring funds between registered accounts for an embodiment of the present invention.

### DETAILED DESCRIPTION

Referring now in detail to an embodiment of the invention, an example of which is illustrated in the accompanying drawings, an embodiment of the present invention makes use, for example, of a payment engine that facilitates the making of payments between two individuals, such as someone who wants to send money to a child at college, via the Internet. A person-to-person aspect of an embodiment of the present invention enables the making of such payments between individuals without the necessity of using, for example, checking accounts or savings accounts to fund those payments. The person-to-person aspect allows two people to use their credit cards, for example, to facilitate an on-line person-to-person transaction. An embodiment of the present invention makes use of an engine built, for example, on a bank cards technology platform of a financial institution, such as a bank, which enables features, such as allowing users to purchase at on-line merchants using monies that they received as cash in a person-to-person transaction.

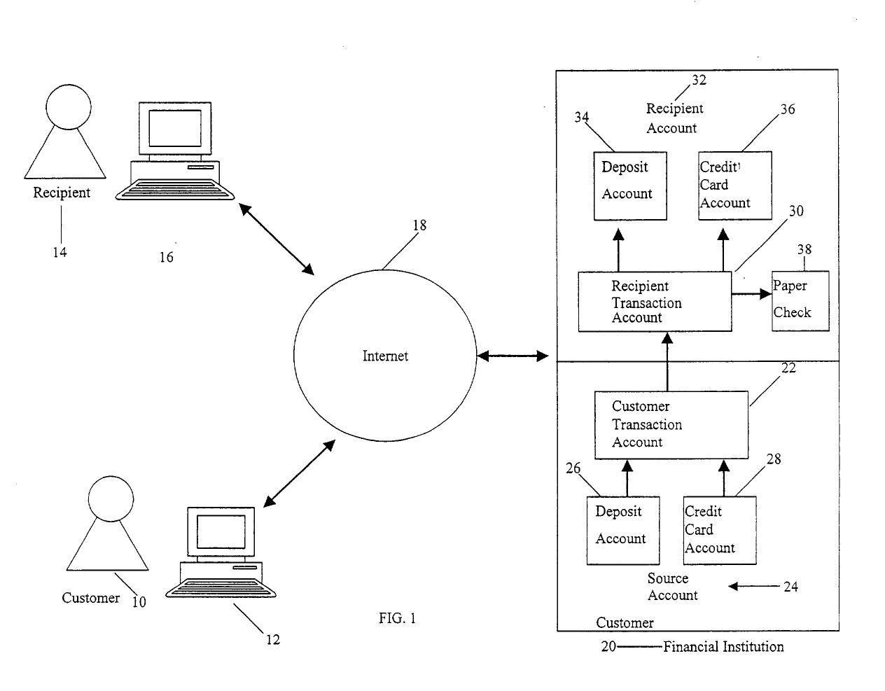

FIG. 1 is a schematic flow diagram that illustrates an overview of an example of key components and the flow of information between key components for a person-to-person payment aspect of an embodiment of the present invention. Referring to FIG. 1, key components include, for example, a customer 10 at a terminal 12, such as the customer's personal computer (PC), and a recipient 14 at a terminal 16, such as the recipient's PC, coupled via the Internet 18 to a service provider, such as a financial institution 20. Other key components include, for example, a customer's transaction account 22 and a source account 24, such as deposit account 26 and/or credit card account 28, and a recipient's transaction account 30 and a recipient account 32, such as deposit account 34 and/or credit card account 36.

Referring further to FIG. 1, when the customer 10 is enrolled into the service for an embodiment of the present invention, the customer 10 is assigned a “pass-through” or transaction account 22, which is a repository for the flow of funds into and out of the account, depending upon the transactions in which the customer 10 engages. Thus, the customer 10 that registers for the service is able to have funds reside in the transaction account 22 and to transmit funds from that account 22 to other users, such as recipient 14, once the recipient is also enrolled. It is not necessary for the recipient 14 of funds to have a credit card account 36 or a bank account 34. If the recipient 14 of funds does not have a credit card account 36 or a bank account 34 and chooses not to register for the service, a courtesy check 38 is issued by the system of the present invention for the funds that are received. However, the sender 10 of funds needs a source account 24, such as a debit or checking account 26, or a credit card account 28 as the source of funds.

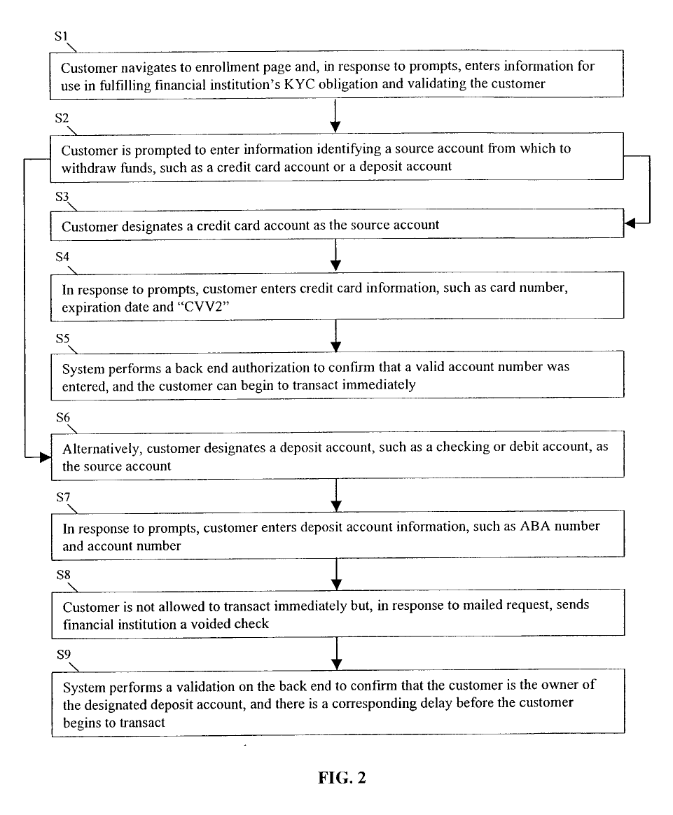

A feature of the person-to-person payment aspect of the present invention is an enrollment process. FIG. 2 is a flow chart which shows an example of the enrollment process for the person-to-person payment aspect of an embodiment of the present invention. Referring to FIG. 2, assume that a potential customer sees an advertisement for the service for an embodiment of the present invention on his or her Internet service provider's web site. At S1, the customer 10 is brought to an enrollment page where the customer 10 is asked to enter some critical information. The information is necessary to fulfill the financial institution's “know your customer” (KYC) obligation, and the information is also relevant, for example, in settling disputes. Critical information is collected from the customer 10 at the front end to secure as much information as is necessary to abide by KYC rules and to enable the financial institution 20 to have enough information to validate that the customer 10 is in fact a good faith, legitimate individual. In addition, the financial institution 20 makes use of a series of protection safeguards leveraging the financial institution's bank card database to deal with money laundering and fraud issues, including monitoring on a daily and weekly basis.

Referring further to FIG. 2, At S2, the customer 10 is also asked to enter information identifying a source account 24, which is the source from which the customer 10 intends to withdraw the funds. The source account 24 choices include, for example, credit card accounts, such as credit card account 28, and debit or checking accounts, such as deposit account 26. At S3, if the customer 10 designates a credit card account, such as credit card account 28, at S4, the customer 10 is also asked to enter critical information, such as the card number, the expiration date, and a card verification value (CVV2), which is an identifier on the reverse side of the credit card as a security feature that allows the system to know that the customer 10 has the card present in his or her immediate possession. When the credit card information is entered, at S5, the system performs a back end authorization to confirm that a valid account number was entered.

Referring again to FIG. 2, alternatively, at S6, if the customer 10 chooses, for example, a deposit account 26, such as a checking account, as the source account 24, at S7, the customer 10 must provide information, such as the ABA number and account number of the deposit account 26 that is designated. The designated bank can be any bank that has a valid ABA number or any bank that is a member of the ACH or any other valid account, such as a mutual fund money market account. If the customer 10 designates a demand deposit account (DDA) as the source of funds, the customer 10 is not allowed to transact immediately. Instead, at S8, the customer 10 is sent information in the mail asking the customer 10 to attach a voided check, so that at S9, the system can perform a validation on the back end to confirm that the customer 10 is the owner of the deposit account 26 that is designated. Thus, there is a delay of from a week to ten days before the customer 10 can use his or her checking account 26 as the source account 24.

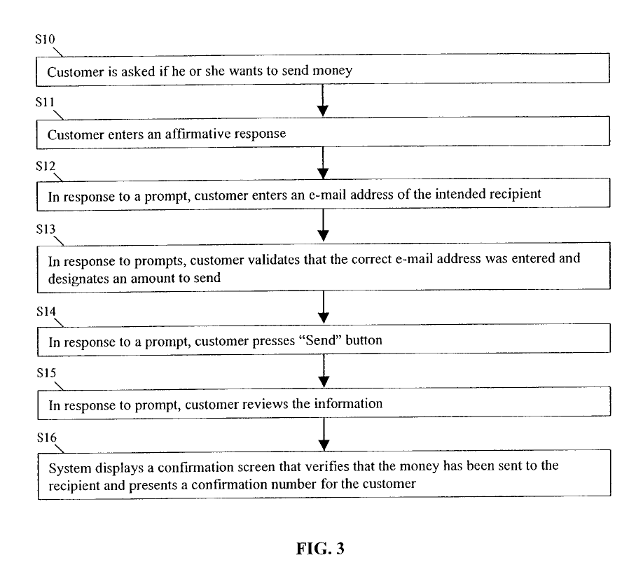

FIG. 3 is a flow chart which illustrates an example of the person-to-person payment process for an embodiment of the present invention. If the customer 10 designates a credit card account 28 as the source account 24 for the funds, the customer 10 can start to transact immediately after entering the information. Referring to FIG. 3, when the credit card information is entered and the system performs the back end authorization to confirm that a valid account number was entered, at S10, the customer 10 is asked if he or she wants to send money. At S11, if the customer 10 responds in the affirmative, at S12, the customer 10 is asked to enter an e-mail address of the intended recipient 14. At S13, the customer 10 is asked to validate that the correct e-mail address was entered and to designate an amount. At S14, the customer 10 presses “Send” and is asked to review the information at S15. At S16, the system then displays a confirmation screen that verifies that the money has been sent to the recipient 14 and presents a confirmation number for the customer 10.

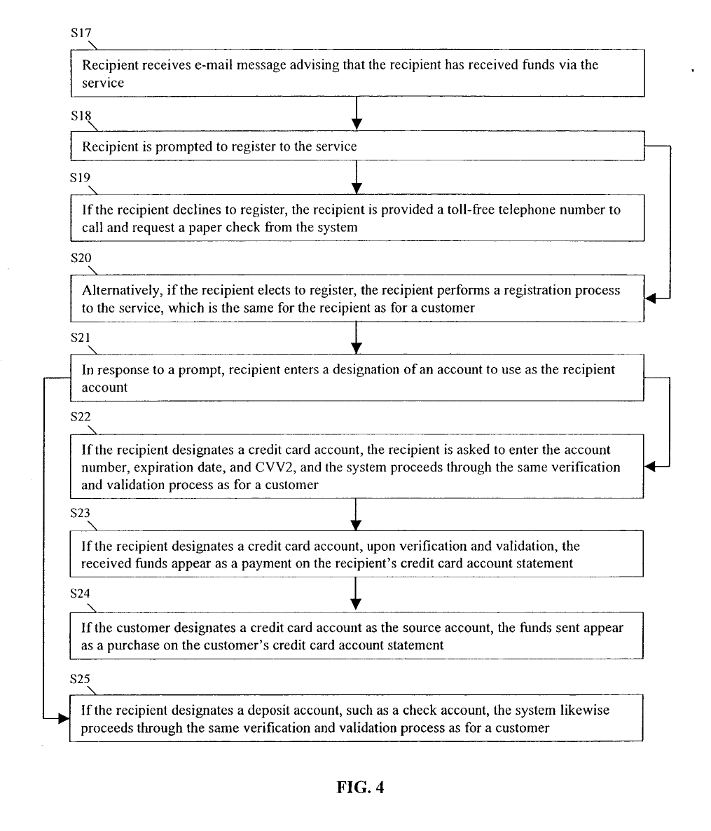

FIG. 4 is a flow chart which shows an example of the process of receiving a person-to-person payment for an embodiment of the present invention. Referring to FIG. 4, while the recipient 14 is browsing through the recipient's e-mail, for example, at S17, the recipient 14 discovers that he or she has an e-mail message advising that the recipient 14 has received the funds. At S18, the recipient 14 is asked to register to the service of the present invention to receive the funds. If the recipient 14 does not want to enroll in the system, at S19, the recipient 14 is provided, for example, with a 1-800 telephone number to call and request a check 38 from the system. Thus, the system does not hold a recipient's money hostage, and the money is made available to the recipient 14 with proper checks and balances. If the recipient 14 elects to register, at S20, the recipient 14 performs a registration process which is the same for the recipient 14 as for the customer 10. Once the recipient 14 completes the registration process, at S21, the recipient 14 is able to designate which account he or she wants to use as the recipient account 32. If the account designated by the recipient 14 is a credit card account 36, at S22, the recipient 14 is asked to enter the account number, the expiration date, and the CVV2.

Referring further to FIG. 4, if the recipient 14 enrolls and designates a credit card account 36 as the recipient account 32, at S23, the money appears as a payment on the recipient's credit card statement. This is an important feature, which means, for example, that there is no degradation of points or cash back. On the other hand, if the customer 10 designates the customer's credit card account 28 as the source account 24, at S24, the payment shows up as a purchase on a statement for the designated credit card account 28. This is also an important feature, which means, for example, that it does not appear as a cash advance with associated fees and interest. If the recipient 14 designates a checking account 34, at S25, the system proceeds through the same verification and validation process as it did for the customer 10, in order to minimize the opportunity for fraud. Thus, the enrollment process is the same for both a customer 10 and a recipient 14.

A merchant payments aspect of an embodiment of the present invention introduces deposit account functionality and debit card functionality, which enables purchases to be made at merchants directly, for example, from the recipient transaction account 30. For example, assume that the recipient 14 is sent a birthday gift of $50 via the person-to-person functionality of the present invention. In the merchant payments aspect, the recipient 14 is able to accept the $50 gift that was received and deposit the gift, for example, into a corresponding checking account 34, or apply the gift against the recipient's credit card account 36, or use the $50 gift to shop at a web site on line, or actually go to a retail store and make a $50 purchase with the gift. For example, assume that the customer 10 sends $50 to the recipient 14 as a birthday gift via the system for an embodiment of the present invention. The recipient 14 is sent an email notifying the recipient 14 of receipt of the money from the customer 10, and the recipient 14 logs into the system to pick up the $50 gift, for example, with a “Happy Birthday” message attached. The $50 gift is then held in the recipient's account 30 with the system, and the recipient 14 can do any one of a number of things with it. For example, the recipient 14 can leave the $50 gift in the account 30 until the recipient 14 accumulates the rest of the birthday gifts that the recipient 14 anticipates receiving.

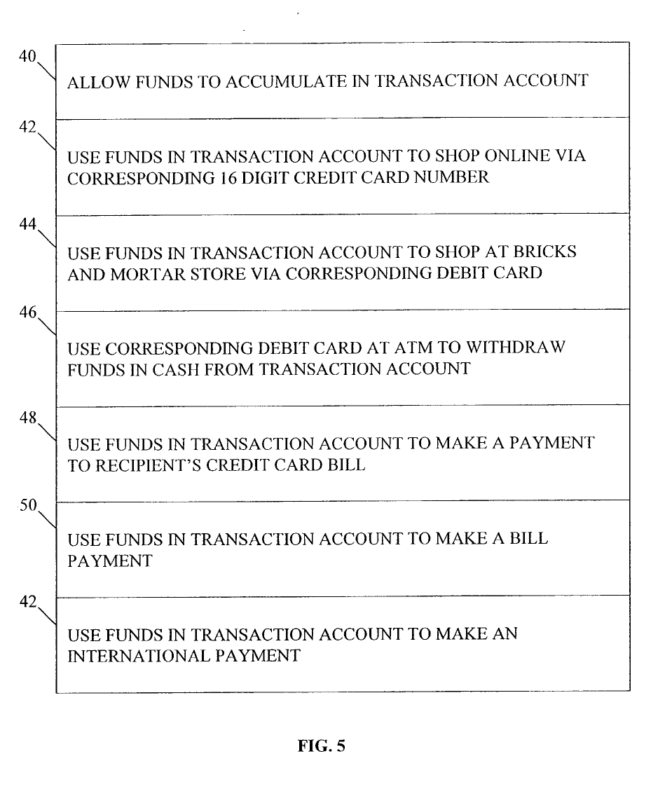

FIG. 5 is a table which illustrates examples of uses of funds in the transaction account for an embodiment of the present invention. Referring to FIG. 5, options of the recipient 14 include, for example, accumulation 40, on-line shopping 42, bricks and mortar store shopping 44, ATM cash withdrawal 46, credit card account payment 48, bill payment 50, and international payment 52. The recipient 14 can simply leave the $50 gift in the account 30 in anticipation of doing something with it later. The recipient 14 can spend the $50 gift, for example, via an on-line purchase by using a 16 digit credit card number that corresponds to the account 30 that is issued to the recipient 14 at the time the recipient enrolls in the service. The recipient 14 can take a debit card that is issued to the recipient at enrollment to a bricks and mortar retail merchant, such as a supermarket, gas station, or retail outlet, and shop with the $50 gift. The recipient 14 can also go to an ATM, and for a fee, withdraw the $50 gift, or whatever remains of it, from the ATM. Alternatively, the recipient 14 can use the $50 gift to pay the recipient's credit card bill account balance or make a payment to the recipient's credit card account 36, if the recipient 14 does not have a balance.

The transaction account 30 for an embodiment of the present invention enables the recipient 14 to save or accumulate the money that is received. The transaction account 30 is a depository account subject to all of the rules and regulations of any bank account. It is an account with an account number that can be used, for example, to make purchases from a merchant by furnishing the merchant the account number. Users who qualify are given, for example, a 16 digit debit card, which can be used in an ATM to withdraw cash. The recipient 14 can either shop on-line or take the plastic card to a merchant store to shop. An embodiment of the present invention enables the recipient 14 to receive a payment from another person, such as customer 10, and to use the payment for shopping 44 or to withdraw the payment in cash 46 at an ATM for a fee. The transaction account 30 functions as a hub for all of these transactions, whether the recipient 14 receives a person-to-person payment, for example, as a birthday present or uses the recipient's own checking account 34 to fund the transaction account 30. The transaction account 30 is the hub through which payments can be made, for example, to another person for an auction purchase or shopping web site 42, or for a purchase through the debit card at a local retail store 44, or for an international payment 52.

In the method and system for an embodiment of the present invention, the transaction accounts 22 or 30 become the hub in a butterfly concept, which utilizes a variety of funding sources, designated generally as 24 on the customer side and 32 (recipient account) on the recipient side in FIG. 1. The system provider can be a financial institution 20, such as a bank, and the funding sources 24, 32 can be banking accounts with the service providing bank or with other financial institutions or banks. It is not necessary for a customer, such as customer 10 or recipient 14, that uses the system to have banking accounts with the service providing bank 20. The customers 10 or 14 register a series of accounts that can be used as funding sources 24 or 32, and the monies that the customers 10 or 14 fund goes into the customers' transaction accounts 22 or 30. The funds can then be sent from the transaction accounts 22 or 30, according to the customers' instructions, for example, to other individuals, such as from customer 10 to recipient 14 (or vice versa), to charities, to pay the customers' bills, to make payments on the customers' credit cards, for deposit into another checking account at another institution, to shop, or to get the cash out of an ATM. Thus, the transaction accounts 22 or 30 can be used to make any payments, such as international payments 52, merchant payments, bill payments, cash payments with ATM withdrawals 46, and/or credit card payments 48, and functions as the center of any consumer payment transaction.

An “all account” aspect of an embodiment of the present invention provides an account referred to herein as the “all account”, which offers customers of the person-to-person payments aspect of the system, such as customer 10 or recipient 14, the opportunity to receive a debit card with a 16 digit credit card number which draws funds from the customer's transaction account 22 or 30 so that the customer, such as customer 10 or 14, can shop. A plastic card is issued to every customer 10 or 14 who wants one, so that the card can be used in the physical world as well as the virtual one. Customer 10 or recipient 14 can self-fund their respective transaction accounts 22 or 30 by transferring money into transaction accounts 22 or 30, or customer 10 or recipient 14 can use money received through the person-to-person payment service. An extremely important feature of the “all account” for an embodiment of the present invention is an additional credit utility attached to the “all account” for credit-eligible customers.

The 16-digit number access card number is known to the customer 10 or recipient 14 but is not shown during authorization, unless the customer 10 or recipient 14 requests the number and successfully answers several electronic identification verifier questions. If the customer 10 or recipient 14 does not want an access card number, the customer 10 or recipient 14 must wait to receive a plastic card in the mail. Upon approval, if the customer 10 or recipient 14 is not given access to a debit card number, the customer 10 or recipient 14 has access only for person-to-person payment functions. Once the customer 10 or recipient 14 receives a debit card, the customer 10 or recipient 14 has full “payment to anyone” access. The access card is the only physical plastic to access monies from a customer's transaction account and/or line of credit. The debit card is used to access funds in the line of credit rather than checks.

The transaction account 22 or 30 has a 16-digit number that has no credit utility and is not shown to the customer 10 or recipient 14, and a separate bank identification number is established for the transaction account. In addition, an access card number with a 16-digit credit card number has an associated line of credit that uses the same account number, and a separate bank identification number is established for the line of credit. The transaction account 22 or 30 contains “save for later” money and, for a sender, “held money” that has not yet been taken by a recipient. The customer 10 or recipient 14 is shown the “save for later” and the “held money” portions of the transaction account 22 or 30. The transaction account 22 or 30 is tied to the access card number within the cards division of the service provider 20. The access card is able to access both the transaction account 22 or 30 and the line of credit. During a transaction, the “save for later” money is used first, and when used up, the line of credit is accessed.

The addition of credit functions to customers' transaction accounts in the system of an embodiment of the present invention enables the system provider 20 to receive 100% of the interchange on purchases as well as interest on revolving balances, thus heavily impacting profitability for the system provider 20. In addition, instead of requiring customers, such as customer 10 and/or recipient 14, to take an immediate action with the money in their transaction accounts 22 or 30, the “save for later” functionality is a cornerstone for the “all account” that allows customers to leave money in their transaction account 22 or 30, sometimes referred to herein as the “clip”, with which customers can later fund any of the available transaction types, such as person-to-person payments or merchant payments. Further, a bill payment service adds functionality for customers to use their credit card accounts as source accounts to pay bills through the bill payment service.

In a self-funding feature of an embodiment of the present invention, if the recipient 14 of a $50 gift from the customer 10 via the person-to-person payment aspect wishes to make a purchase that exceeds the amount of the gift, the recipient 14 can take it a step further. For example, if the recipient 14 wishes to buy something from a web merchant or retail store for $100, the recipient 14 can self-fund the recipient transaction account 30 with an additional $50, so that he or she has $100 in the account 30 to spend. In other words, the merchant payments aspect expands the functionality from simply accepting and depositing value to the recipient's account 30, to allowing the recipient 30 to shop with the value that is deposited. The value appears, for example, as a payment on the recipient's credit card account 36. Thus, when the $50 gift received by the recipient 14 is moved to the recipient's credit card account 36, it shows up as a payment and applies, for example, to the recipient's minimum payment due. On the other hand, if the recipient 14 has a zero balance, the $50 gift shows up as a credit balance on the recipient's credit card account 36, so the recipient 14 has money in the account 36 that is available to spend.

Another aspect of an embodiment of the present invention is a “person-to-anyone” payments aspect, which provides other payment options for the customer 10 or recipient 14, in addition to person-to-person payments, such as the ability to pay merchants for purchases. In extending the basic functionality of the system of the present invention, the focus of the payment to anyone aspect shifts from a money transfer service to a money deposit account that the customer 10 or recipient 14 can use as a source and a destination of funds. In this aspect, the user interface refers to the transaction account 22 or 30 as a “clip”, and customers are directed to focus on the “clip” 22 or 30 as the center of their on-line financial life. The merchant payments aspect for an embodiment of the present invention addresses a currently unmet customer need to be able to utilize money received in the person-to-person transaction account 22 or 30, for example, to shop.

In addition, the merchant payments aspect for an embodiment of the present invention leverages the strength of the existing credit card business of the service providing financial institution 20. The concept of the “clip” 22 or 30 is a key feature of the system for an embodiment of the present invention. The “clip” 22 or 30 is perceived by a customer, such as customer 10 or recipient 14, as an omnipresent mechanism for managing and using the customer's money both on-line and off-line. The “clip” becomes the customer's repository for incoming and outgoing funds, enabling a “person-to-anyone” payments system architecture. In an embodiment of the present invention, a “clip” frame is displayed on every page of the user interface (UI). Further, a “Your Balance” frame of the UI contains “Total Available”, “Cash Available”, “Line of Credit”, “Add Money”, and “Logoff”. In making the “clip” the central point of the customer's financial life on-line, an embodiment of the present invention provides usability improvements to the HTML interface layer.

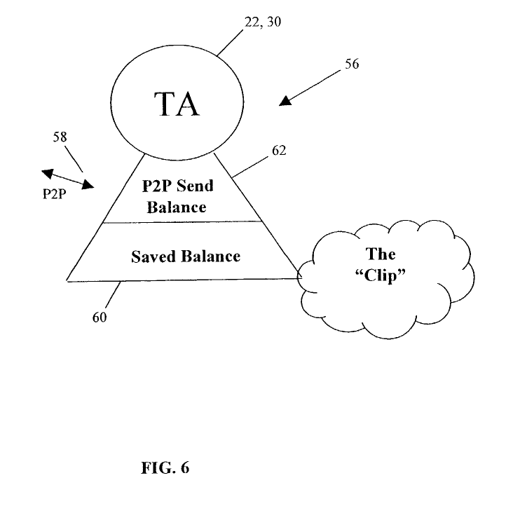

In order to accommodate needs of different customers, the system for an embodiment of the present invention provides varying service levels. Matching the right product to the customer 10 or 14 is done with a combination of customer choice and credit scoring initiated by the system. The levels of service for the “all account” include, for example a basic or “silver” service, a premium or “gold” service, and an ultimate or “platinum” service. FIG. 6 is a schematic diagram that illustrates an example of properties of the “all account” at the basic or silver level of service for an embodiment of the present invention. The basic or silver service 56 provides a full person-to-person payment service 58 with the addition of “save for later” functionality 60. All person-to-person payment customers qualify for the silver level of service 56. The customer 10 or 14 is able to receive and send money from the customer's transaction account 22 or 30. The transaction account 22 or 30 is classified as a deposit account and contains a “save for later” portion 60 and a “held money” portion 62, which represents money that the customer 10 or 14 has sent to a recipient, which has not yet been picked up by the recipient. The customer 10 or 14 does not receive an access card (plastic) or a line of credit for the basic or silver service 56, but the customer 10 or 14 can upgrade from the silver level of service 56 to a higher level of service.

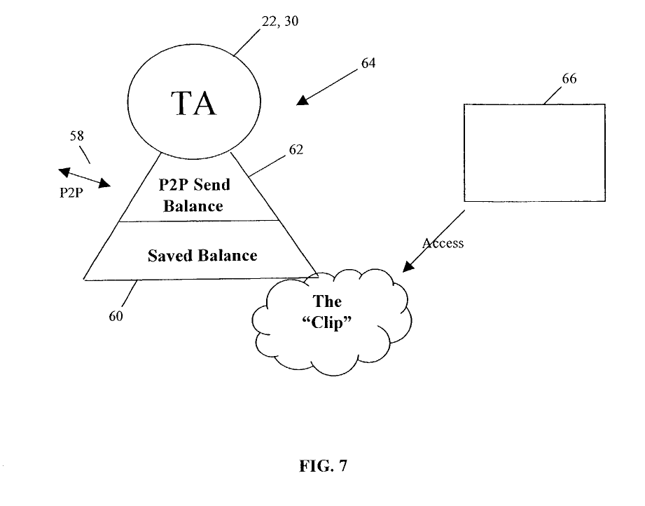

FIG. 7 is a schematic diagram that illustrates an example of properties of the “all account” at the premium or gold level of service 64 for an embodiment of the present invention. The premium or gold service 64 provides full person-to-person payment service 58, with debit card functionality and a plastic card 66. Customers who either decline a credit line or are not eligible for a credit line qualify for the gold level of service 64 and receive a plastic card 66 for use in the off-line world. The gold level of service 64 includes the silver level of service 56, and the transaction account 22 or 30 is the same as the silver level of service 56, but with no credit line. An access card (plastic) 66 is issued to access the “clip” or transaction account 22 or 30, and there is one access card 66 for each transaction account 22 or 30. Each transaction account 22 or 30 is tied to an email. Each customer 10 or 14 is allowed up to three transaction accounts.

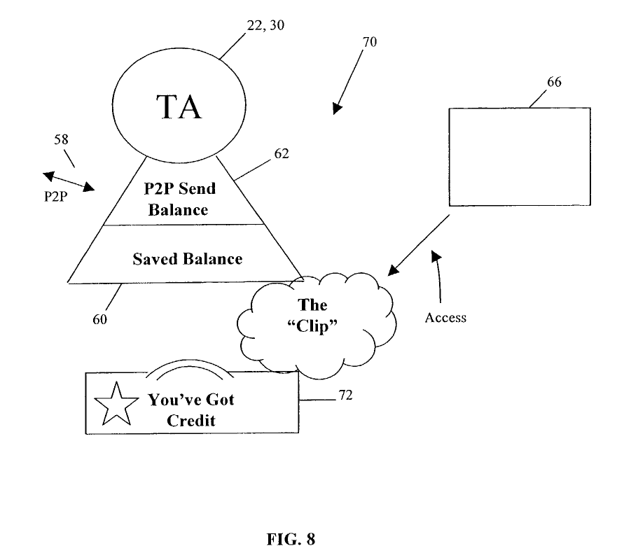

FIG. 8 is a schematic diagram that illustrates an example of properties of the “all account” at the ultimate or platinum level of service 70 for an embodiment of the present invention. The ultimate or platinum service 70 provides full person-to-person payment service 58 with full debit card functionality, and with the addition of a credit line 72. The platinum level of service 70 includes the silver 56 and gold 64 levels of service, except that the “clip” or transaction account 22 includes the customer's saved balance 60 plus the amount of the customer's line of credit 72. The access card (plastic) 66 is issued to the customer 10 or 14 to access both the line of credit 72 and/or the saved balance funds 60.

In an embodiment of the present invention, a “level indicator” is created and appended to the customer's enrollment file and used at future logins to drive the UI. All customers have a persistent window/toolbar which appears on all screens. All customers are able to view their available credit line 72, available cash 60 and their total available credit line 72 and cash 60. The customer's level of service determines what is displayed for the customer's line of credit 72. Customers at the platinum level 70 have an amount displayed for their line of credit 72, but for customers at the gold 64 and silver 56 levels, the line of credit has “$0” displayed for a line of credit. Customers are able to add money to their “clip” or transaction account 22 using a button on the window/toolbar. Shopping, form fill and password memory functionality is also provided to aid customers in shopping.

Through the enrollment process for an embodiment of the present invention, the customer 10 or 14 may or may not qualify for a debit card 66 and/or a line of credit 72, which can be characterized as an overdraft protection. The customer 10 or 14 is evaluated when the customer enrolls, and there may be one or more reasons why the customer may not qualify for a credit or debit card 66. The minimum that the customer 10 or 14 receives, however, is the transaction account 22 or 30, which can be characterized as a deposit account and is as simple as going to a bank and opening up a savings account. The enrollment process is a significant aspect of the system of the present invention, because it involves conditionally approving customers, based upon an approval process. The approval process becomes a very significant aspect because it requires performing an evaluation that is sufficient to determine what level of service to offer the customer 10 or 14. The levels of service include, for example, the basic level 56 that is the deposit or transaction account 22 or 30, the premium level 64 that is the deposit or transaction account 22 or 30 plus the debit card 66 to access the customer's money, and the ultimate level 70 that is the deposit or transaction account 22 or 30 with the debit card 66, plus an overdraft credit line of protection 72.

In the system and method for an embodiment of the present invention, other services offered to customers, such as customer 10 and recipient 14, include, for example, a bill payment service, as well as additional financial payment services. The bill payment aspect enables the customer 10 to facilitate the payment of bills and the presentment of the customer's bills via the Internet 18. Thus, the system of the present invention provides a single place for users, such as customer 10 and recipient 14, to go to transact all of their payments, such as merchant payments or person-to-person payments, using all available payment mechanisms, such as a paper check through the ACH system or a credit card to the merchant's system. The system for an embodiment of the present invention also includes, without limitation, any other bilateral payment process or private payment activity between individuals.

The bill payment aspect for an embodiment of the present invention integrates bill payments into the service and provides an option, for example, to the recipient 14 of the $50 gift to use the gift to pay the recipient's bills. Thus, the recipient 14 can take the $50 gift and send it to the telephone company or electric company or to the recipient's gardener to pay the recipient's bills, using a bill payment service. The bill payments aspect utilizes a bill payment service either to make the payment directly or to cut a check, depending upon the payee of the bill payment. The system of the present invention does not necessarily make payments directly to a biller, for example. but uses and integrates a bill payment product of the service provider 20.

The system for an embodiment of the present provides major advantages over existing bill payment service. In existing bill payment services, a user signs up his or her checking account as the funding source to pay bills, and each month, the user proactively pays his or her bills electronically. For example, the user goes on-line via the Internet and picks the bills and the amounts that the user wants to pay, and on the same day, the user's checking account is debited for the amounts indicated. Thereafter, if the payee, such as the telephone company, has a capability to receive an electronic payment, the payee receives an electronic funds transfer made from the user's checking account by the bill payment provider directly to the payee. If the payee, such as the user's gardener, has no such capability, the payee is sent a check that is cut for the particular bill payment, and the gardener receives the check in the mail. The system for embodiment of the present invention replaces the user's checking account with the transaction account 22 or 30 as the funding source for those bill payments. The transaction account 22 or 30 is subject to the same federal and state regulations for banking as any other deposit account, such as a savings account or checking account.

In an international payments aspect of an embodiment of the present invention, a customer, such as customer 10 or recipient 14, can utilize the system to send, for example, a wire or check payment abroad to foreign countries. In addition, customers who are residents outside the United States, such as a customer residing in London, can log on the web site for the system and enroll in the service for an embodiment of the present invention. The customer can then use the system, for example, to make person-to-person email payments to other United Kingdom residents or to other recipients in different countries.

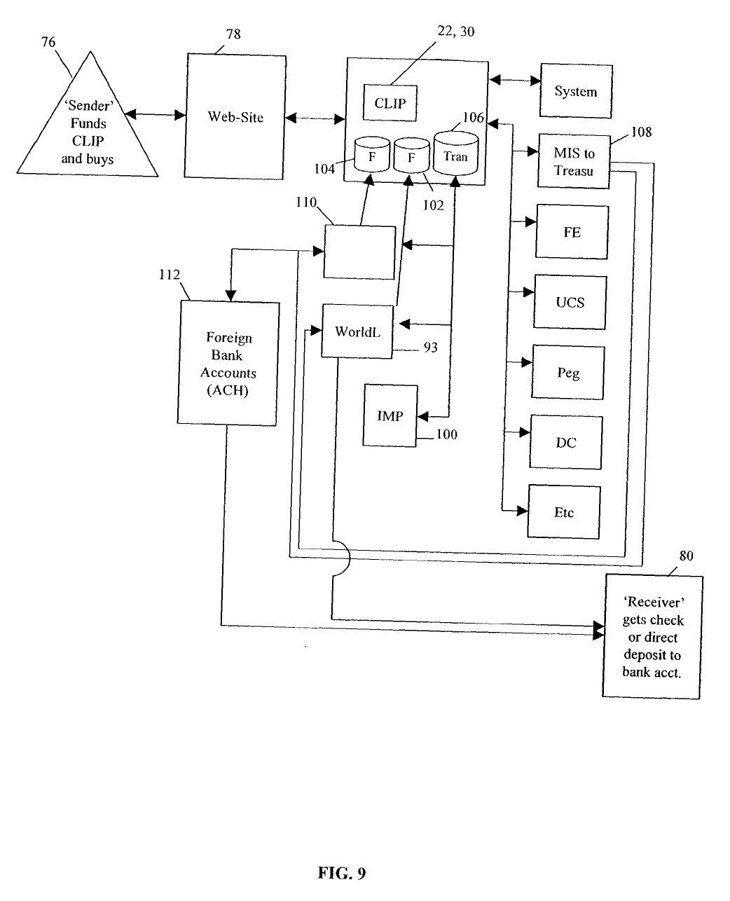

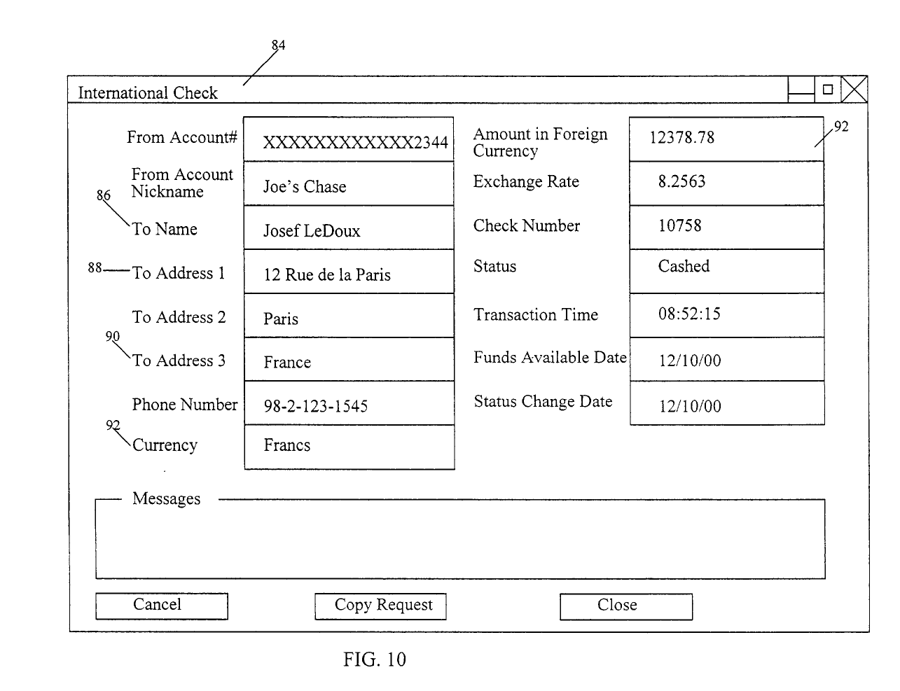

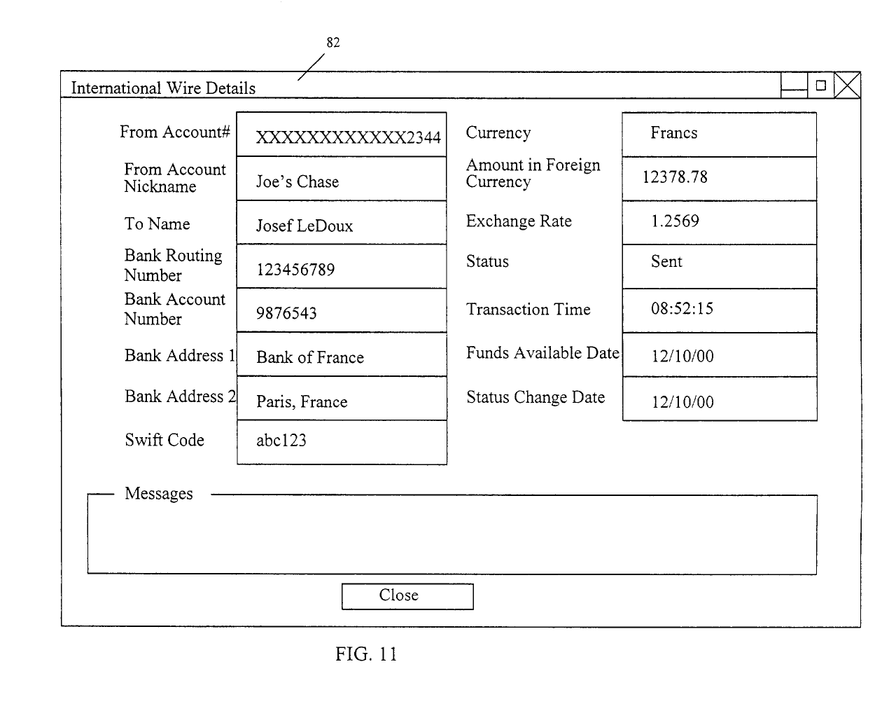

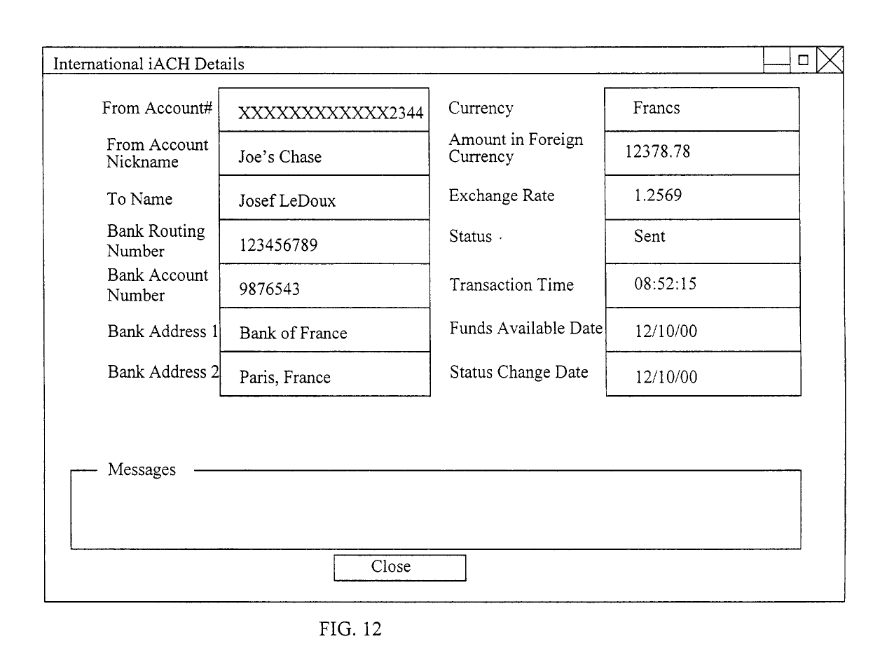

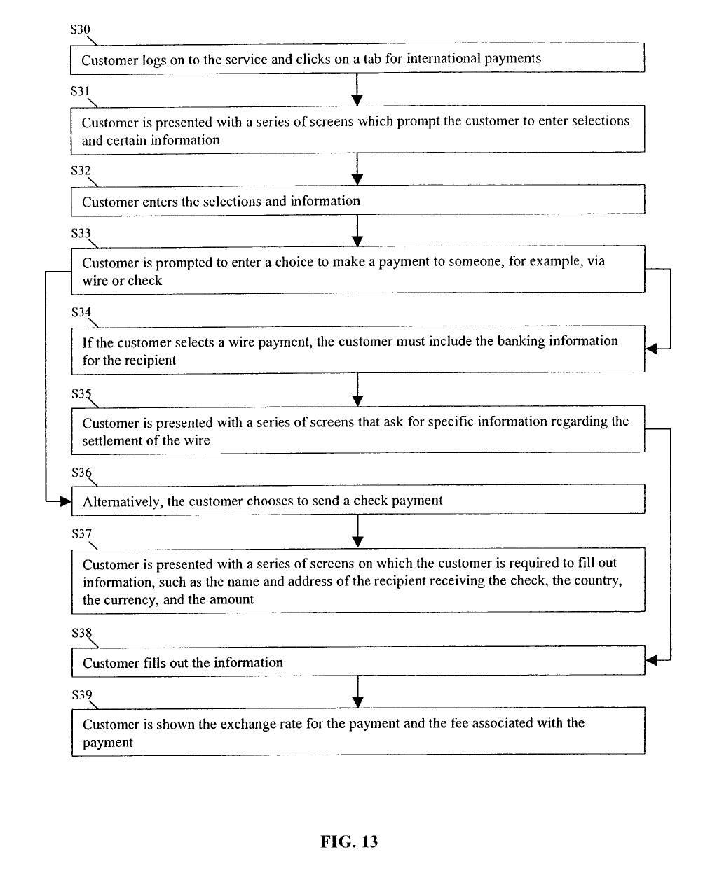

FIG. 9 is a schematic diagram which illustrates an example overview of key components and the flow of information between the key components of the international payments aspect of an embodiment of the present invention. FIG. 10 shows a sample user interface screen for an international check payment aspect; FIG. 11 shows a sample user interface screen for an international wire payment aspect; and FIG. 12 shows a sample user interface screen for an international ACH payment aspect of an embodiment of the present invention. FIG. 13 is a flow chart which illustrates an example of the process of initiating an international payment on the system for an embodiment of the present invention.

Referring to FIGS. 9-13, at S30, a sender 76, such as customer 10 or recipient 14, logs on the service for an embodiment of the present invention, and clicks on a tab for international payments. At S31, the sender 76 is presented with a series of screens which prompt the sender 76 to enter selections and certain information. At S32, the sender 76 enters the selections and information and, at S33, the sender 78 is prompted to enter a choice to make a payment to someone, for example, via wire or check. At S34, if the sender 76 selects a wire payment, the sender 76 must include the banking information for the recipient 80, and at S35, the sender 76 is presented with a series of screens, such as international wire details screen 82, that ask for specific information regarding the settlement of the wire. Alternatively, at S36, if the sender 76 chooses to send a check payment, at S37, the sender 76 is presented with a series of screens, such as international check details screen 84 on which the sender 76 is required to fill out information, such as the name 86 and address 88 of the recipient 80 receiving the check, the country 90, the currency 92, and the amount 94. At S38, the sender 76 fills out the information, and at S39, the sender 76 is shown the exchange rate for the payment and the fee associated with the payment.

The international payments aspect for an embodiment of the present invention provides a global payment platform that enables customers, such as customer 10 or recipient 14, to pay anyone, anywhere, anytime. A feature of the international payments aspect of the system of the present invention provides domestic customers with the ability to purchase a multi-national payment via check, international Automated Clearing House (iACH), or wire from the customers' U.S. dollar system transaction accounts. Another feature of the international payments aspect of the system involves expansion outside the U.S. and the addition of other countries to the system network. As each new country is added, there is full transfer functionality between accounts, and customers are able to move monies between currencies and cross-border in real time.

The international payments aspect for an embodiment of the present invention provides a capability for customers to send checks, iACHs, and wires in foreign currency through the use of third party vendors and services developed by the system provider 20 for large corporate customers that need to execute high volume, low value payments and collections in multiple countries. Such system provider developed services include a service that allows corporations to make payments via check in many different foreign currencies, referred to herein as WorldLink 98. The account 22 or 30 of the sender 76 is debited in its base currency and a check issued from an omnibus account 112 in the designated currency. The checks are sent to the recipient 80 via mail from processing centers, for example, in Europe and the U.S. WorldLink 98 also provides wire transfer capability in many countries.

Another such system provider developed service is a service that provides a single interface to numerous domestic low value clearing or Automated Clearing Houses (ACH/GIROs) globally, referred to herein as International Mass Payment Service/International Direct Debits (IMPS/IDD) 100. IMPS/IDD 100 allows corporate customers to transmit instructions for payments or debits to recipients in multiple countries. Via a single interface, customers can transmit a high volume of transactions, in a single electronic file, in a single format, via a single means of connectivity and security.

The international payments aspect of the present invention provides functionality, such as international checks, iACH payments, and wire transfers. With regard to international checks, system users are able to purchase multi-currency checks in any of a number of available foreign currencies, initiated in the U.S. from the system web site 78. Check orders are accumulated in a transaction journal log 106 throughout the day. Once per day, data in the transaction journal log 106 is batched and transmitted to a WorldLink 98 data center in the U.S. WorldLink 98 conducts edits on the file, kicks out rejects, and routes the remaining ‘good’ orders to a check printing facility, for example, in London. Checks are printed on check stock with local bank sort codes and account numbers so that the checks are treated as local collection items by the depositing institution. Checks are mailed, for example, from London to the destination country. Exception items, such as rejects/returns, are notified to the system each day via facsimile. A PC-based customer service system is available to the system to request check stop payments and check photocopies.

With respect to iACH payments, system users, such as sender 76, are able to purchase a payment into a foreign bank account in any of a number of foreign countries via the local ACH system, initiated in the U.S. from the system web site 78. IACH orders are accumulated in the transaction journal log 106 throughout the day. Once per day, data in the transaction journal log 106 is batched and transmitted to IMPS 100 via a global file handler (GFH). The GFH scans the file for format errors and either accepts or rejects the entire file. If accepted, the file routes to IMPS 100, and IMPS 100 sends instructions to a local system account 112 in the appropriate foreign country. Payments are made into the local clearing systems in each country, funded from the system's local account 112 in each country. Rejects and return credits are refunded to the system's local accounts 112, and notification is sent to the system via facsimile each day for reconcilement purposes. Phone customer service is available for to system users for iACH dispute/repudiation exceptions.

For wire transfers, system users, such as sender 76, are able to purchase a wire transfer, for example, via Society for Worldwide Interbank Financial Telecommunication (SWIFT) into a foreign bank account in any one of numerous foreign countries. Wire transfer orders are accumulated throughout the day in the transaction journal log 106. Once per day, the transaction journal log 106 is batched and transmitted to WorldLink 98 in the same process and destination as for international checks. Check and wire transfer orders are in the same file, and WorldLink 98 splits out the orders. Wires and ACH payments are directly deposited into the account of the recipient 80. Checks are sent in the mail to the recipient 80 for deposit into the bank account of the recipient.

Payment for purchases of the foreign currency can be made from the system clip or transaction account 22, 30 and all other credit card accounts. Silver 56, gold 64, and platinum 70 level customers are eligible for system international purchases. Silver 56, gold 64, and platinum 70 level customers can access and use the value in their clip or transaction account 22, 30 or any credit card to buy a check, iACH, or wire. As used in the discussion of the international payment aspect herein, the term “send” means loading value into a system account 22 or 30, and the term “purchase” means the purchase of an international payment from a system account 22 or 30. As also used in the discussion of the international payment aspect herein, the term “sender” 76 means an enrolled silver 56, gold 64, or platinum 70 level system customer who initiates an international transaction, and the term recipient 80 means a beneficiary of an international transaction who is not a system customer.

An interface to WorldLink's and IMPS' data center provides, for example, foreign exchange (FX) rates fixed daily. Rates are set for the system based on desired spreads, which are built into a daily rate table 102 provided by WorldLink 98 for checks and wires. A financial institution F/X system 110 provides a daily FX rate table 104 for iACH payments. There are two separate FX rate tables 102, 104 transmitted to the system each day, each with potentially different rates for each currency. The two rate tables 102, 104 are used because IMPS 100 does not provide FX and cash management service for iACH payments. Check, wire issuance, and/or iACH payments are captured in the transaction journal log 106, batched and transmitted to WorldLink 98 and IMPS 100 each day. The interface also provides MIS 108 to the system on all transactions, so that the system treasury can perform FX purchases and account management functions. Confirmation files are sent from WorldLink 98 each day as well as a file of check status, such as paid/outstanding. This file is loaded into the system and the system user's status is updated on the system user's transaction history 106. In addition, the interface provides reconcilement tools/exception handling via the WorldLink PC-based system. Further, the interface provides debit and credit to the system omnibus account for WorldLink 98 and debits and credits to system local currency accounts for IMPS 100.

Because, unlike WorldLink 98, IMPS 100 does not provide FX and cash management services, the system for an embodiment of the present invention establishes a bank account 112 in each foreign country and arranges for foreign currency to be in each account 112 in order to fund the iACH payments each day. The financial institution's F/X system 110 provides both the foreign exchange and the daily funding of the system accounts 112. The IMPS/IDD platform sorts, reformats, validates and distributes the individual transactions to the appropriate ACH/GIROs or other payment platform in time to meet the required value dates. Credits/debits are processed in a timely manner, which is a benefit to the issuing customer. IMPS/IDD 100 provides access to a comprehensive array of payment and collection methods, for example, in North America, Europe, Latin America, and Asia, as well as Central and Eastern Europe, Middle East, Africa and South Asia (CEEMEA), that include payments/collections in foreign countries, such as ACH/GIRO payments, ACH collections, and remote cheques via WorldLink 98.

The system for an embodiment of the present invention links to a financial institution FX system trading desk 110 and the FX desk for WorldLink 98 and receives FX rate tables 102, 104 with rates guaranteed for 24 hours. This enables the system for the present invention to provide users with guaranteed FX rates when they purchase international transactions. Each day, at a designated time, which occurs at the same time the prior day's batch transaction journal log is cut, the FX tables 102, 104 are transferred to and loaded into the system. These new rates are used for the next 24 hours.

For IACH FX processed via the financial institution's FX system 110, when the daily transaction journal log 106 is batched, a file that summarizes the total amount of each currency is sent to the financial institution's FX system 110. This file is loaded into the financial institution FX system's chief dealer system. The treasury of the system of the present invention uses the financial institution FX system's confirmations on the Web system to view and approve the daily FX order. Once the treasury approves the order, the financial institution FX system 110 purchases the FX and wires the money for two-day settlement to the local accounts 112 for the system of the present invention in each of the countries where iACH payments are available via IMPS 100. IMPS 100 holds each day's order for 2 days before executing payments out of the local accounts 112 of the system to ensure that the accounts 112 are adequately funded by the financial institution's FX system 110. When iACH rejects/returns occur, credits are routed into the local accounts 112 of the system, and IMPS 100 provides details to the system's treasury via fax. The system treasury uses the chief dealer system to execute small FX trades, such as selling and buying U.S. dollars needed to ensure that the sender 76 is credited for rejects/returns at the current FX rate.

For check and wire transfer purchases processed via FX of WorldLink 98, a main difference between the FX system of the financial institution 110 and the FX system of WorldLink 98 is that the system treasury faxes the daily FX order to the FX desk of WorldLink 98. WorldLink 9F then purchases the FX and uses its own accounts around the world to fund the checks and wires. Credits for exceptions are routed back to the system's omnibus account in the U.S. The system treasury ensures that the sender 76 is credited for rejects/returns/stop payments at the current FX rate.

While a majority of countries have similar requirements for processing wire transfers and iACH payments, some variations exist. The file formats provided by IMPS 100 and WorldLink 98 comprise all possible variations. However, users of the present system, such as sender 76, are prompted on the system web site 78 to input certain required data depending on the country selected by the system user. For example, certain countries may require the beneficiary's phone number in the payment instructions while other countries do not require this information. Additionally, the system of the present invention may impose its own country variations for risk management and business purposes. For example, different per transaction limits may be specified depending on the country selected.

In the international payments aspect, the system for an embodiment of the present invention, for example, accepts international payment orders from the web site 78, creates a daily file of transaction detail orders, and transmits the orders to IMPS 100 and WorldLink 98. The system creates a daily file of FX currency totals to send to the FX system of the financial institution 110, accepts files from WorldLink 98, IMPS 100 and the FX system of the financial institution 110, such as FX rate tables 102, 104, transaction status, confirmation files, and a paid and stopped check file, and debits and credits the sender's clip or transaction account 22 for all transactions and fees.

In addition, the system for an embodiment of the present invention, for example, ensures that all transaction data is maintained, generates various reports for settlement, including a new transactions report that details each new transaction initiated through the payment processor and a new transactions summary that is a summary of the information in the new transactions report, tracks senders' transactions and dollar amounts against their limits and country specific limits, halts a sender's ability to transact if the sender exceed limits, and accepts adjustments from customer service/operational areas to the sender's clip or transaction account 22 and transaction history log 106.

Further, the system for an embodiment of the present invention, for example, loads new FX rate files received from WorldLink 98 and the financial institution's FX system 110, with the countries supported, into a table each weekday and calculates a percentage mark-up (variable) based upon the FX rate for each country, stores all information until a transaction is completed or abandoned so the sender 76 does not have to re-enter all information, and determines the correct FX rate table to use (WorldLink 98 or the financial institution's FX system 110) for iACHs, checks, and wires.

In the international payments aspect for an embodiment of the present invention, for example, the system web site 78 captures information about a send transaction, such as a transaction number, country, local currency code, product type, such as check, wire, or ACH, exchange rate, amount in foreign currency, fees, total amount due, payment options, and recipient name, address, telephone, routing number, account number, bank name and address. The system validates, for example, maximum amount limits against transaction dollar amounts according to a fraud policy, a recipient name and address against specially designated nationals (SDN) lists, and if there are sufficient funds on the trading account 22 of the sender 76. Edit and cancel options are available to the sender 76 before a transaction confirmation is processed. The sender 76 is able to view on-line, details of the sent transaction including, for example, a transaction reference number, a transaction amount, fees, recipient data, and status of a check or wire. The system performs the function to send International payments via middleware and displays and assesses fees for transactions. Dynamic terms and conditions are defined for each of the levels of service.

An aggregator aspect of an embodiment of the present invention enables the a customer, such as customer 10 or recipient 14, to view all of the customer's financial information in one space using aggregating technology. Thus, the customer 10 or 14 is able to see the balances and transactions from all of the customer's on-line financial services providers and to see the customer's entire financial picture in one space. Once the customer 10 or 14 enrolls, the customer is offered an opportunity to participate in other services that are available to members, such as the aggregation process. The customer 10 or 14 engages in that service by completing several items of information to collect the data that is required for the aggregation process.

The aggregator process is a balance aggregator. Thus, assume that the customer 10 or 14 has a checking account with a particular bank, a loan with another bank, a money market account with a brokerage firm, and various certificates of deposit with one or more savings banks that all have on-line services. The aggregator process goes out to all of those on-line banks and the brokerage firm and collects the customer's account information and displays that information for the customer 10 or 14 on one screen in one consolidated way. The aggregator process performs screen scraping and is available at the customer's election. The aggregator process does not involve payments but facilitates the customer's payments, because it enables the customer 10 or 14 to know what the customer has in the various accounts.

In a user interface aspect for an embodiment of the present invention, for example, labels are hyperlinked with pop up windows that explain the field with additional context help as appropriate. Javascript is used for real time validation of all required fields. Information collected from the customer 10 or 14 is displayed on edit/confirm pages. The customer 10 or 14 is allowed to edit the information necessary, and data entry is simplified. Error messages are generated by an Internet layer, based on requirements of fields and tables. These messages are specific and user-friendly. User information for each session is cached on the Internet level to facilitate additional flexibility in both display and capture of information, as well as greater speed.

Other features of the user interface for an embodiment of the present invention include, for example, field validation, user interface modules, page sizing, and error handling. The user interface provides immediate field validation of user entries for reasonability level validation, so as not to be redundant with back-end validation. An advanced example of this is automatically correcting currency input. The UI is defined as a grouping of functionality, termed a UI module. Each module is intended to represent a complete function, such as “enrollment”, “get cash” and “delete account”.

Each module collects user-entered information from one or more web pages and then composes the appropriate middleware call at the end of the process. The user's page automatically sizes correctly regardless of the user's browser and setting of the resolution. If the response from a middleware call is an error, the UI displays the field in error and appropriate error message text within an independent web page and accepts a corrected entry from the user. The middleware call is resubmitted with the corrected entries. The flow continues as if no error had occurred.

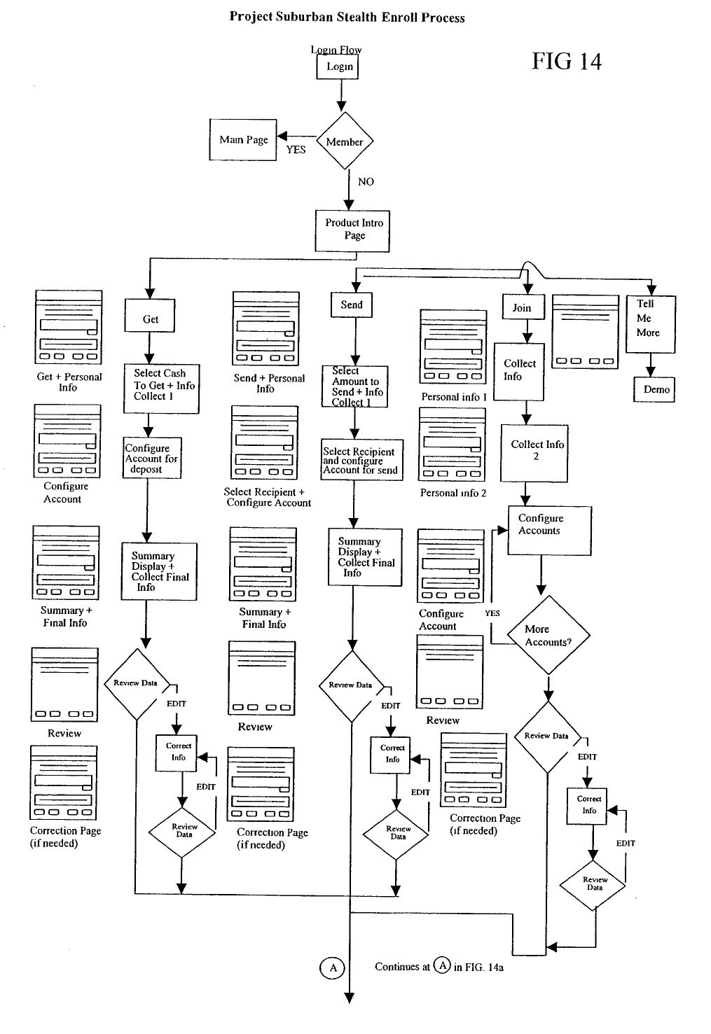

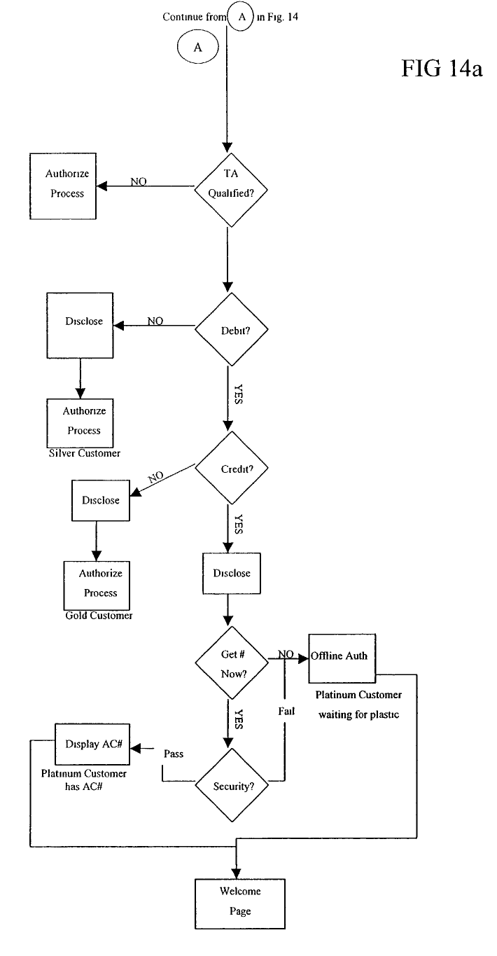

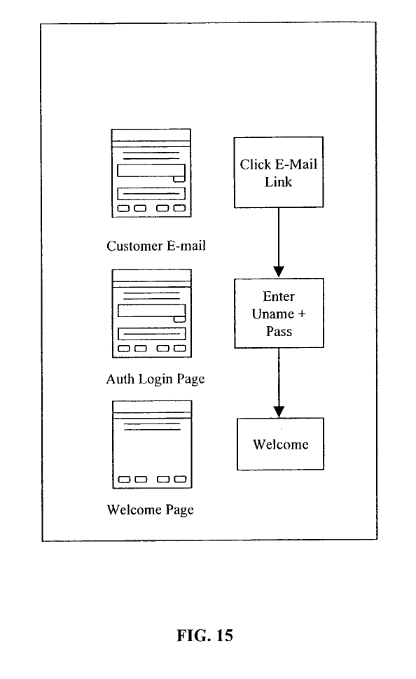

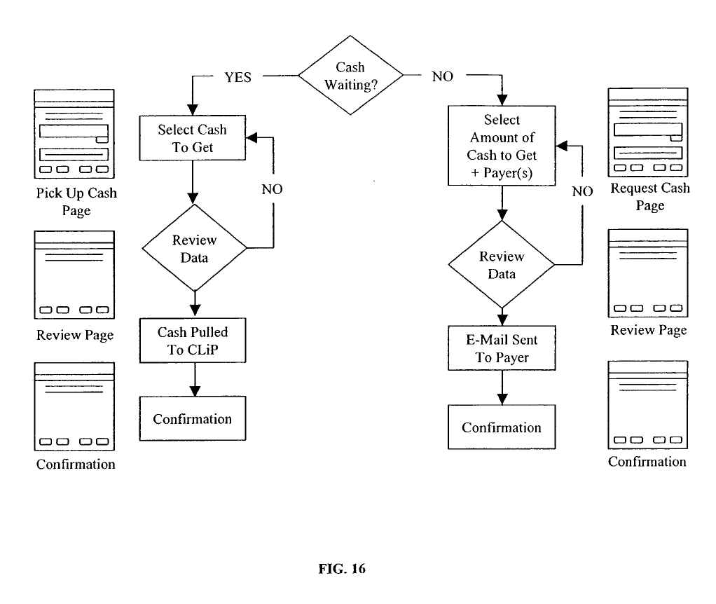

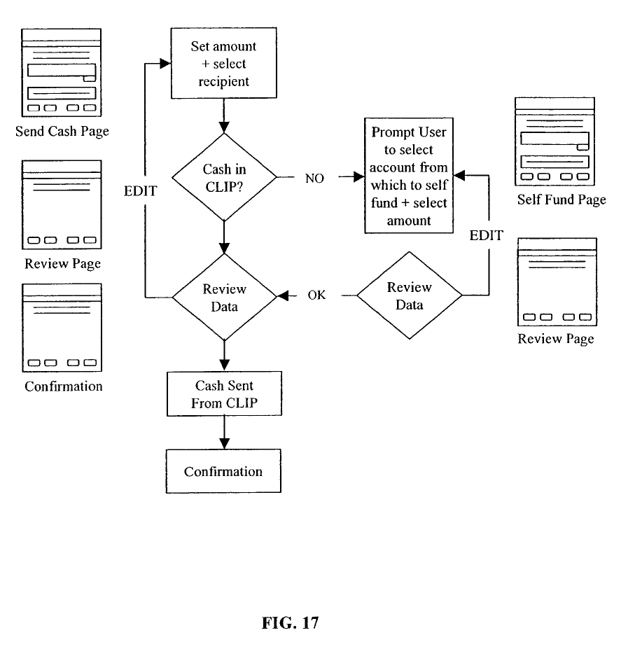

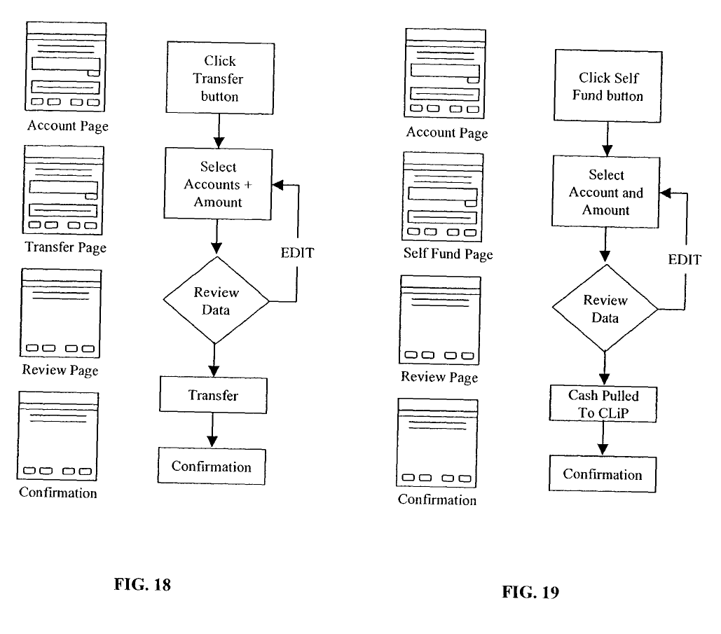

FIGS. 14-25 are flow charts which illustrate examples of modules for the processes of enrollment, authorize member, pick up/request cash, send cash, transfer, self fund, cancel transaction, add account, edit account, delete account, history/statement, and profile update for an embodiment of the present invention. The function of the enrollment module shown in FIGS. 14 and 14a is to enroll the customer 10 in the service as unobtrusively as possible and requiring only the minimum information necessary. FIG. 15 is a schematic flow chart which illustrates an example of the log in process for an embodiment of the present invention. The function of the pick up/request cash module of FIG. 16 is to permit the customer 10 or 14 to obtain cash and accommodates both a single pick up and a multiple pick up. The function of the send cash module in FIG. 17 is to provide options and information necessary to send cash and accommodates a single send cash. The function of the transfer and self fund module illustrated in FIGS. 18 and 19 is to transfer funds from one account to another account, such as to and from the transaction account 22 or 30 with a “self-funding” look and feel and to pay the credit line 72.

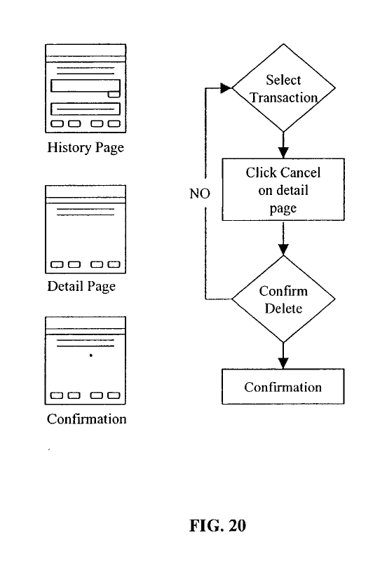

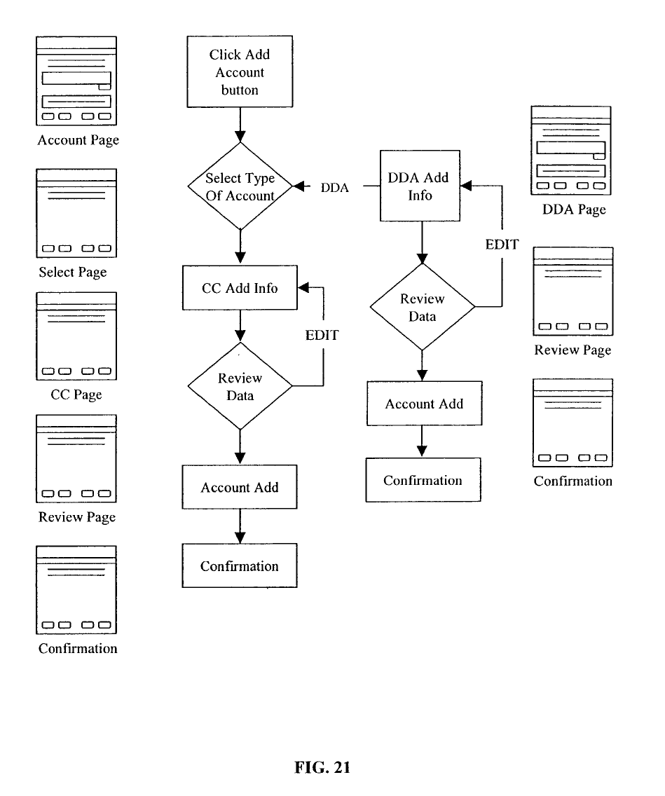

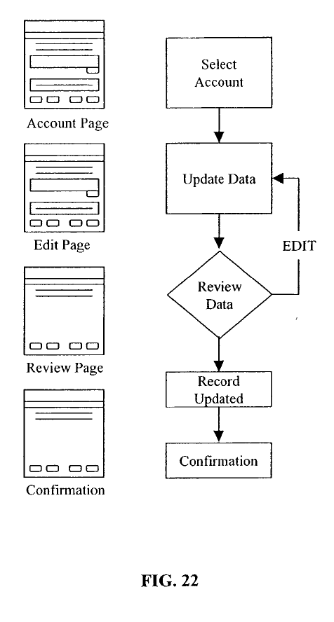

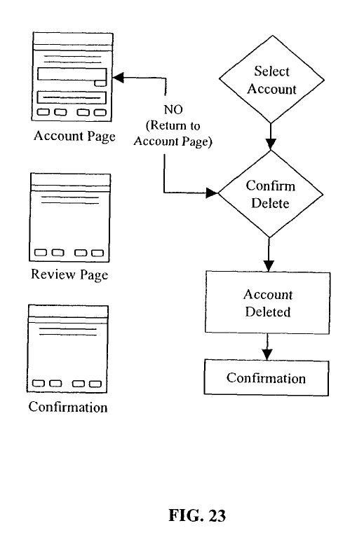

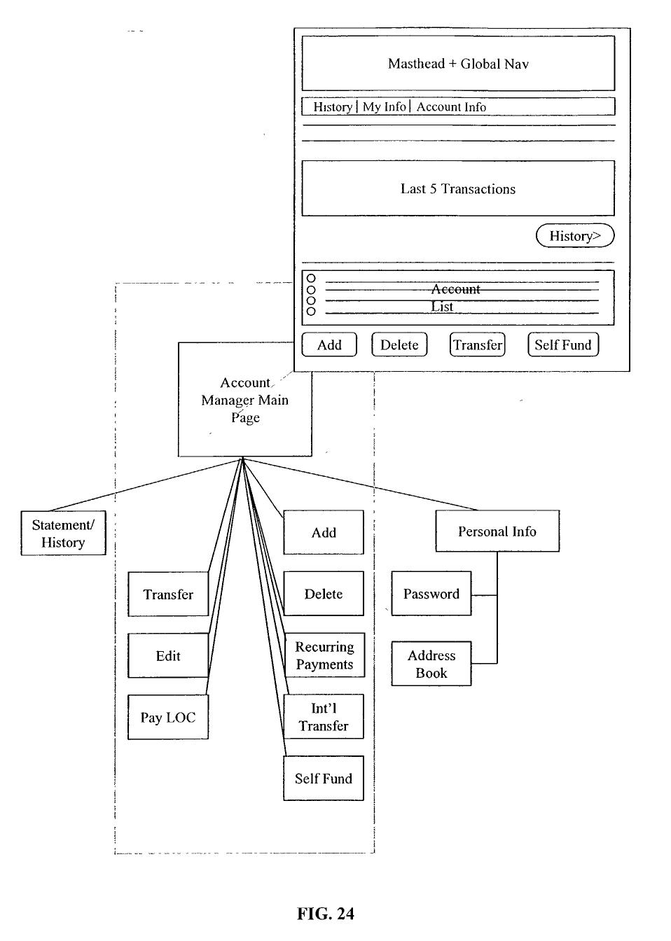

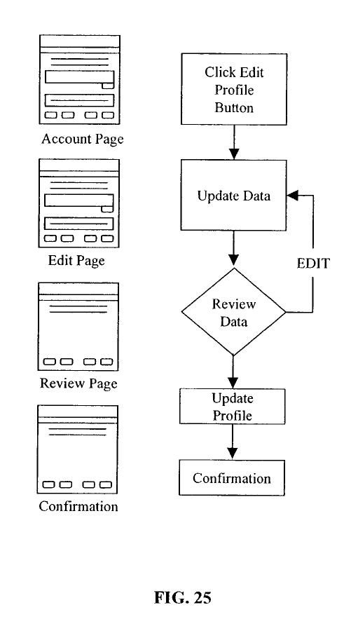

The function of the cancel transaction module shown in FIG. 20 is to allow the customer 10 or 14 to cancel a transaction on-line. The function of the add account module illustrated in FIG. 21 is to permit the customer 10 or 14 to add accounts, and the function of the edit account module shown in FIG. 22 is to provide options and information necessary to edit profile information or added accounts. The function of the delete account module shown in FIG. 23 is to provide options and information necessary to remove configured accounts from the profile. The function of the history/statement module illustrated in FIG. 24 is to provide summarized transaction information, and the function of the profile update module shown in FIG. 25 is to provide options and information necessary to update the user profile.

Additional features of the user interface for an embodiment of the present invention include, for example, secure messaging, a point of entry into the system, and branding. New registrations enter the system of the present invention via a variety of customized flows. Existing customers have a specific logon page which has the ability to have marketing notices posted to the customer. The system provides the customer several easy ways to come back to the service, including without limitation, cookies and/or bookmarks on the customer's browser and an icon in the browser or server tray. Specific elements of the user interface, such as graphics headers, navigational element graphics, and product names in the text, are brandable for partners

The user interface for an embodiment of the present invention facilitate use by the lowest common denominator of Internet user. Experience indicates that Internet payments typically represent a difficult task for customers. Thus, an embodiment of the present invention includes a robust, interactive “Help” function, as well as a 24×7 electronic care (E-Care) unit by which customers can e-mail questions and receive a guaranteed, quick response. The system includes technical support from the E-Care unit, so if a customer is unable to understand a page, someone is available to walk the customer through the entire process from end to end.

An embodiment of the present invention touches several of the financial institution's systems, such as the financial institution's merchant business, which has a role as the facilitator of payments and in issuing bank credit cards. An embodiment of the present invention also leverages the financial institution ACH system as the facilitator and processor of ACH payments that customers choose to use for checking accounts. In addition, an embodiment of the present invention leverages, for example, a bank card operated accounting system of the financial institution, which is a card member transactions system, as well as the bank card's Internet system that facilitates the Internet backend.

An aspect of the present invention involves providing a service to a variety of distribution partners, such as Internet service providers, search engines, telecommunications providers, to leverage the financial institution's expertise with others' distribution. The system and method for an embodiment of the present invention can be offered in partnership, for example, between a financial institution, such as a bank, and an Internet service provider, and integrated into the service provider's classified and auction section. The system is provided in a component-like manner, which enables distribution partners to pick components of the system in a Chinese menu style by selecting, for example, one or more components from each of several columns.

Another aspect of an embodiment of the present invention provides a quick enrollment process. In the full enrollment process illustrated, for example, in FIG. 2, when a customer 10 goes to the web site for the system of the present invention, the customer 10 actually fills out an application which asks for a wide array of information from the customer 10. The customer 10 is asked to accept the legal disclosures and the terms and conditions, and thereafter the customer 10 is enrolled in the service. In the quick enrollment aspect of the present invention, certain critical information is parsed out to make enrollment a very much shortened and streamlined process, whereby it becomes an enrollment process that is more or less taken out of the front end of the system web site and put into other areas. For example, the shortened enrollment process can be integrated into another web site. In other words, the shortened enrollment process can be put into another web site, such as the web site of a customer's Internet Service Provider (ISP), where customers can go to enroll in the service of the present invention in a shorter amount of time with less information than would be required for the full enrollment process.

In the quick enrollment aspect, for example, under certain conditions, customers who already have an established ISP account are pre-qualified. A requirement of the pre-qualification is that such customers pay their ISP monthly fees using a credit card account, which is true for the vast majority of ISP customers. By facilitating the enrollment process of the on-line payment service of the present invention pre-qualified customers of a preselected ISP, the customer base for the service can be substantially increased. The enrollment process is made very easy, for example, because most of the data is pre-filled with information provided by the ISP. Thus, in the quick enrollment process, customers are required to key in a new password and accept the terms and conditions and Graham-Leach-Bliley Privacy Act (GLB) disclosures, and the account is active after acceptance of the terms and conditions.

In the full enrollment process illustrated, for example, in FIG. 2, all customers of the ISP are treated as applying as new customers of the system of the present invention, and their relationship with the ISP is not taken into consideration during enrollment. In other words, in the full enrollment process, no data is passed from the ISP to the system, and numerous variables are required in that process, including, for example, email address, password (newly assigned), first and last names, suffix, home street, city, state, and zip code address, day and evening phones, Social Security Number, date of birth, acceptance of terms and conditions, GLB disclosures, account nickname, and billing street, city, state, and zip code address.

The quick enrollment aspect for an embodiment of the invention reduces, for example, the number of items which must be keyed in by the customer 10 and makes enrollment far simpler. Thus, the quick enrollment aspect provides an easy enrollment process, which includes the creation of a password and acceptance of terms and conditions and GLB disclosures, followed by a prompt to complete the transaction. For example, a customer's Social Security Number and date of birth are not required to decision the customer's account for the system of the present invention. Further, the preselected ISP's customer data is used to pre-fill most of the fields for verification by the customer 10, such as email address, first name, middle initial, last name, and suffix, home street, city, state, and zip code address, and home phone, and all accounts are conditionally approved with higher limits.

In the quick enrollment aspect, pre-qualification is executed by the preselected ISP based on specific criteria provided, for example, by the financial institution 20. The customer 10 solicited to apply on-line has the pre-filled information provided by the ISP. A Social Security Number and/or date of birth are not required to set-up the customer's account, and social security validation does not occur. In addition, all accounts have a conditional approval flag set, and the credit bureau is not pulled for verification during the enrollment process. Further, all accounts are set up as conditional approvals for future tracking. Conditional approvals are given the risk assessment function the flexibility to adjust limits based on behavior. In additions, no account expiration date is applied on the conditional approval limit.

There is no enrollment form for the customer 10 to fill out in the quick enrollment aspect, such as a Social Security Number and date of birth. Instead, the Internet passes the information required for the applicant to apply for the preselected ISP. The fields that are requested from the ISP include, for example, product/brand, nineteen byte source code, applicant name, applicant signed (default to Y), applicant street address, city, state, and zip code, email address, and affiliate sharing (check box).

The quick enrollment aspect provides a conditionally approved transaction account 22 with minimal verification required by the customer 10. This transaction account has a reduced lifetime transaction limit from the time of enrollment until fully approved. A customer relations management process is employed to request a customer's Social Security Number and date of birth once the customer 10 reaches a pre-set total transaction threshold. Once fully approved, the transaction account 22 follows established functionality and processes, for example, for the existing silver level 56 service. In this aspect, CVV2 checks remain unchanged, and address verification system and card verification value checks are performed when a credit card is linked at the time of enrollment. In the quick enroll aspect, when the customer 10 reaches the customer's predefined transaction threshold, for example, of $500, $1,500 or $2,500 a Fraud Early Warning (FEW) formula drives the customer's account to a specific queue, which generates an outbound e-mail, through the automated process, requesting the customer's Social Security Number and date of birth.

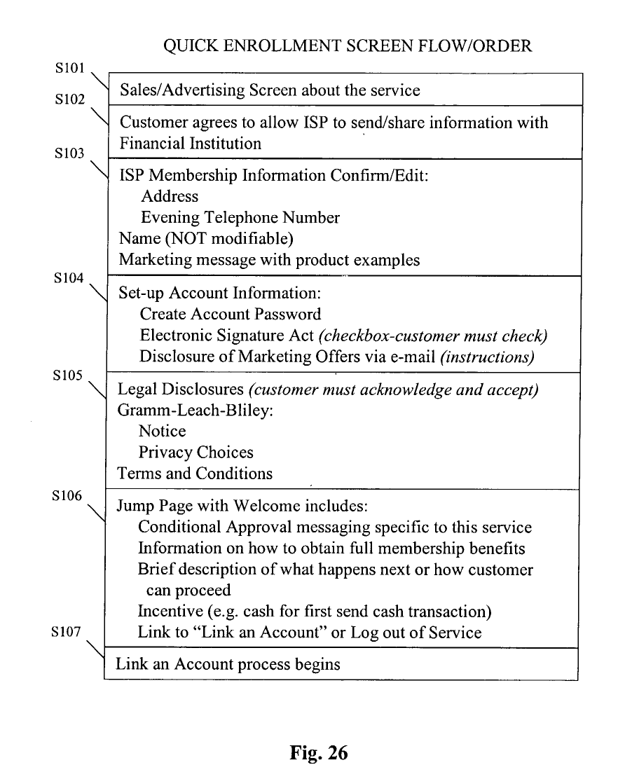

FIG. 26 is a table which illustrates an example of the GUI screen flow order for the quick enrollment aspect of an embodiment of the present invention. For example, at S101, the customer 10 is presented a GUI sales and advertising screen about the service. At S102, the customer 10 agrees to allow the ISP to send to and/or share information with, for example, the financial institution 20 providing the service of the present invention. The customer 10 is thereafter presented an ISP membership information confirm/edit screen at S103, to confirm and/or edit the customer's address, evening telephone number, and name (not modifiable). At S104, the customer 10 is presented a screen for setting up account information that prompts the customer 10 to create an account password and with a checkbox for electronic signature. The customer 10 must acknowledge and accept legal disclosures at S105, such as GLB disclosures and terms and conditions. A jump page with welcome at S106 includes, for example, a service specific conditional approval messaging, information on how to obtain full membership benefits, a brief description of what happens next or how the customer 10 can proceed, an incentive, such as a reward for a first “send cash” transaction, and a link to “Link an Account” or a log out of the service.

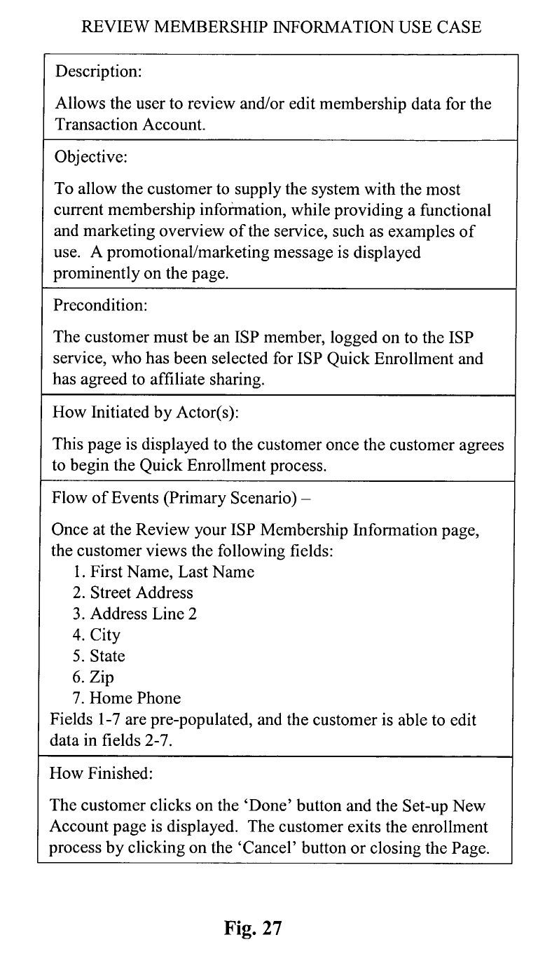

The quick enroll aspect of an embodiment of the present invention involves a number of processes, such as reviewing membership information, setting up account security, agreeing to terms and conditions, and the welcome/conditional/jump page. FIG. 27 is a table which illustrates an example of a use case for the process of reviewing membership information in the quick enrollment process for an embodiment of the present invention. Referring to FIG. 27, the review membership information page allows the customer 10 to review and/or edit membership data for the customer's transaction account 22. The object is to allow the customer 10 to supply the system with the most current membership information, while providing a functional and marketing overview of the service of the invention. A promotional/marketing message can be displayed prominently on this page. As a precondition, the customer 10 must be an ISP member, must be logged on to the ISP service, must have been selected for quick enrollment to the service, and must have agreed to information sharing by the ISP.

Referring further to FIG. 27, the review membership information page is displayed to the customer 10 once the customer agrees to begin the quick enrollment process. Once the customer 10 reaches the review membership information page, a number of fields are presented to the customer, such as first name, last name, street address, city, state, zip, home phone. All of such fields are pre-populated, and the customer 10 can edit data in all but the first and last name fields. When the customer 10 finishes, the customer clicks, for example, on a ‘Done’ button, and the set-up new account page is displayed. At this point, the customer 10 can exit the enrollment process by clicking, for example, on a ‘Cancel’ button or closing the page.

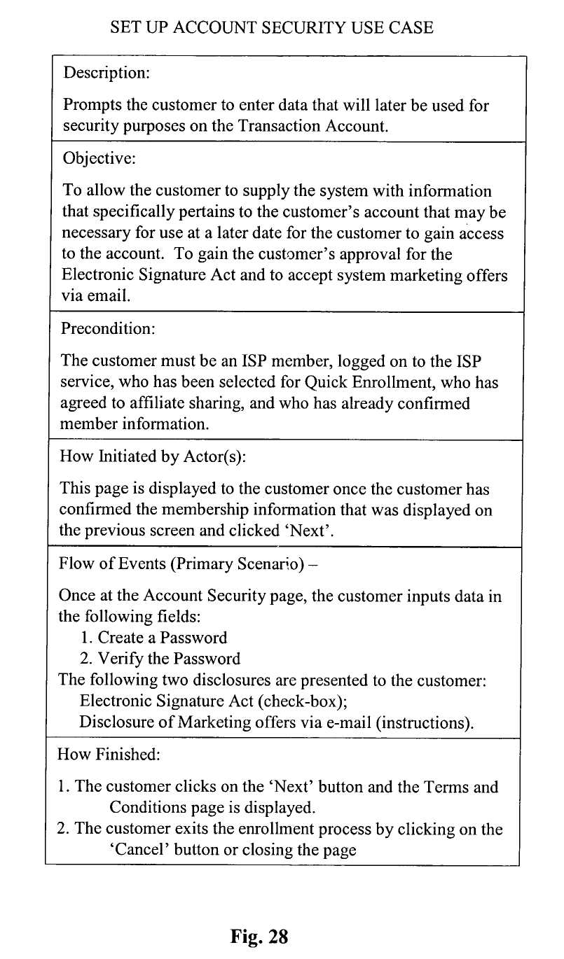

FIG. 28 is a table which illustrates an example of a use case for the process of setting up account security in the quick enrollment process for an embodiment of the present invention. In this process, the customer 10 is prompted to enter data that will later be used for security purposes on the transaction account 22. At this point, the customer 10 is allowed to supply the system with information that specifically pertains to the customer's account that may be needed for use at a later date for the customer 10 to gain access to the account. Other purposes of this process are to gain the customer's approval for the electronic signature act and acceptance of system marketing offers via email. As preconditions, the customer 10 must be an ISP member, logged on to the ISP service, selected for quick enrollment, agreeable to affiliate sharing, and in addition, the customer 10 must have already confirmed member information.

Referring further to FIG. 28, the account security page is displayed to the customer 10 once the customer confirms the membership information that was displayed on the previous screen, and the customer must click, for example, on ‘Next’. Once the customer 10 arrives at the account security page, the customer 10 is prompted to input data in various fields, such as create and verify a password. In addition, the customer 10 is presented with an Electronic Signature Act check-box and disclosure of marketing offers via e-mail instructions. In order to finish the account security process, the customer clicks, for example, on a ‘Next’ button, and the terms and conditions page is displayed. Likewise, the customer 10 can exit the enrollment process by clicking, for example, on the ‘Cancel’ button or closing the page. In this process, the email address is pre-populated and non-maintainable, and the customer 10 must click the check box to agree to the Electronic Signature Act before proceeding.

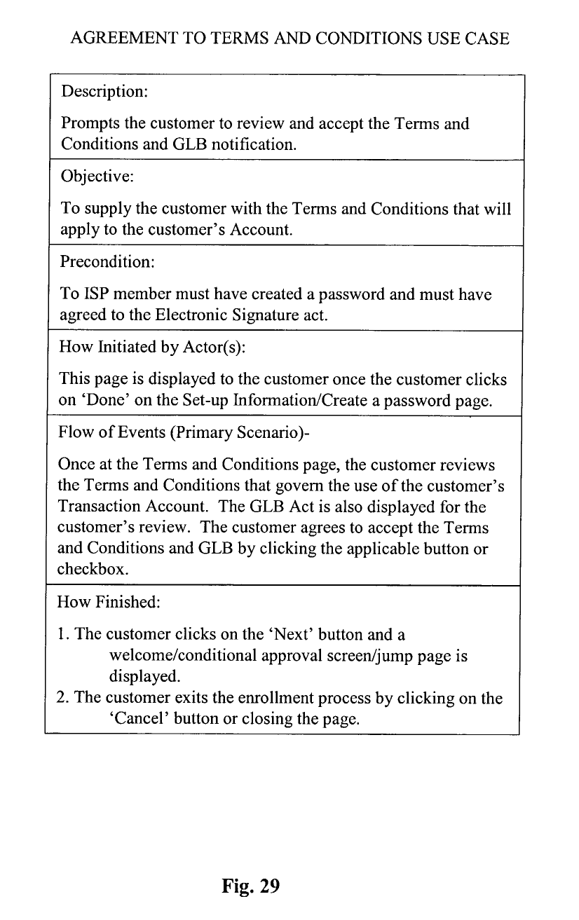

FIG. 29 is a table which illustrates an example of a use case for the process of accepting terms and conditions in the quick enrollment process for an embodiment of the present invention. In this process, the customer 10 is prompted to review and accept the terms and conditions that apply to the customer's transaction account 22 and GLB notification. As a precondition, the ISP member must have created a password and agreed to the Electronic Signature Act, and the terms and conditions page is displayed to the customer 10 once the customer clicks, for example, on ‘Done’ on the set-up account information/create a password page. When the customer 10 reaches the terms and conditions page, the customer reviews the terms and conditions that govern the use of the customer's transaction account 22, and a GLB Act notice with privacy choices are also displayed for the customer's review. The customer 10 agrees to accept the terms and conditions and GLB by clicking the applicable button or checkbox. The customer 10 finishes by clicking, for example, on a ‘Next’ button, and a welcome/conditional approval screen/jump page is displayed for the customer 10. The customer 10 exits the enrollment process by clicking, for example, on the ‘Cancel’ button or closing the page. The customer 10 also has an option to print a copy of the terms and conditions, which appear in a separate window, by clicking on a link.

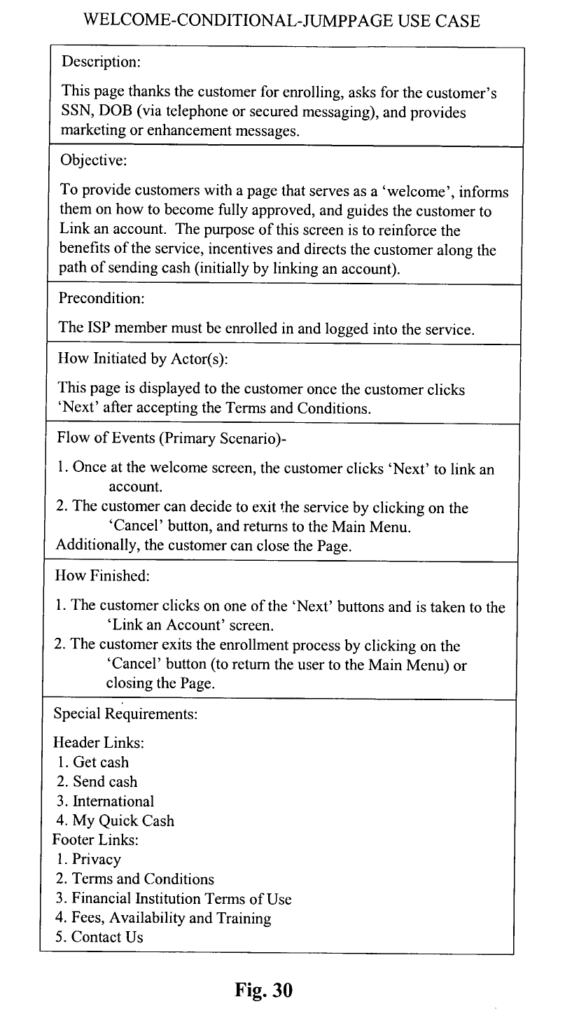

FIG. 30 a table which illustrates an example of a use case for a welcome/conditional/jump page in the quick enrollment process for an embodiment of the present invention. The welcome/conditional/jump page expresses thanks to the customer 10 for enrolling, requests the customer's Social Security Number, and date of birth via telephone or secured messaging, and provides, for example, marketing or enhancement messages. A purpose of this page is to provide the customer 10 with a ‘welcome’, to inform the customer how to become fully approved, and to guide the customer to link an account. This screen reinforces the benefits of the service, incentives and directs the customer 10 along the path of sending cash, initially by linking an account. As a precondition, the ISP member must be enrolled in and logged into the service.

Referring to FIG. 30, the welcome/conditional/jump page is displayed to the customer 10 once the customer clicks, for example, ‘Next’ after accepting the terms and conditions. Once at the welcome screen, the customer 10 clicks, for example, ‘Next’ to link an account. The customer 10 can decide to exit the process by clicking, for example, on the ‘Cancel’ button, whereupon the customer is returned to a main menu, or the customer can close the page. The customer 10 finishes by clicking, for example, on a “Next” button and is taken to a “link an account” screen. The customer 10 exits the enrollment process by clicking, for example, on the ‘Cancel’ button to return to the main menu or by closing the page. Header links for this process include, for example, “Get Cash”, “Send Cash”, “International”, and “My Quick Cash” and footer links include, for example, “Privacy”, “Terms and Conditions”, “Financial Institution Terms of Use”, “Fees, Availability, and Timing”, and “Contact Us”.

A further aspect of an embodiment of the present invention provides an instant availability of funds from the customer's DDA 26 account using a credit card account 28 as a backup. In this aspect, a fund transfer capability is available to the customer 10 which enables the customer to move money, for example, from the customer's checking account 26 in one bank to the customer's checking account in a different bank. If the customer 10 enrolls a credit card account 28 that has been verified to be the customer's credit card, the customer 10 is provided an instant availability of funds. Even though clearing is through the normal ACH process, those funds are not held for the amount of time that is normally required to ensure sufficient, guaranteed funds. Instead the customer 10 is provided instant availability of funds using the credit card account 28 that the customer 10 enrolled as a collateral. A feature of this aspect is that the customer 10 is also offered an alternative to using the credit card as a backup. For example, the customer 10 can use a bank's product, such as bank's proprietary ATM network, to ensure there are funds available in the checking account 26. In order to accomplish this, it may be necessary for the customer 10 to furnish the customer's PIN or secret password for the customer's checking account 26.

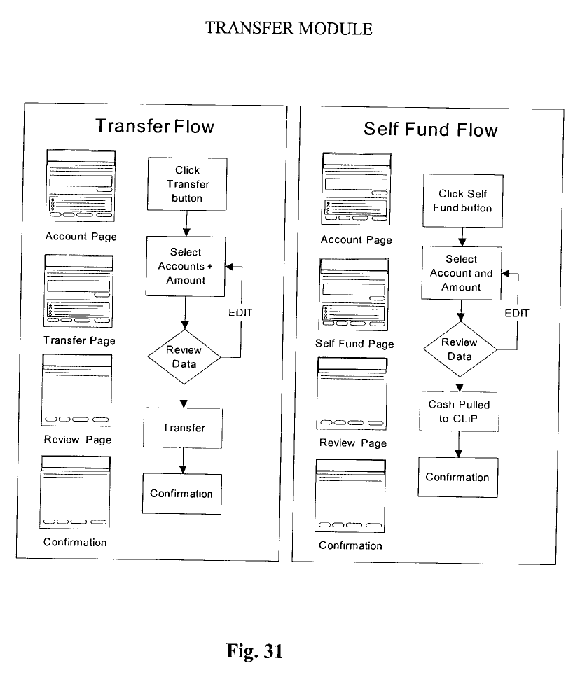

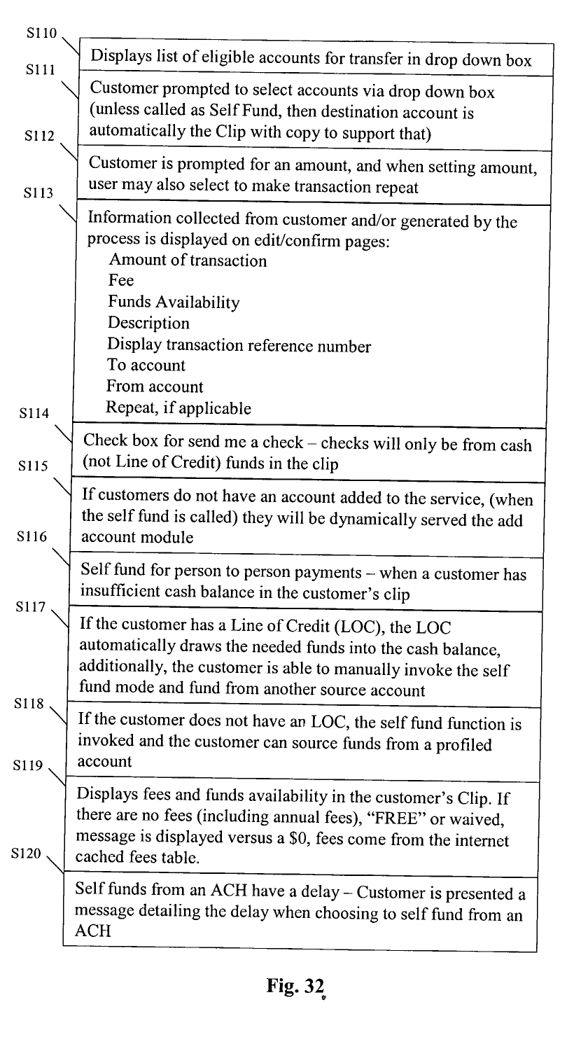

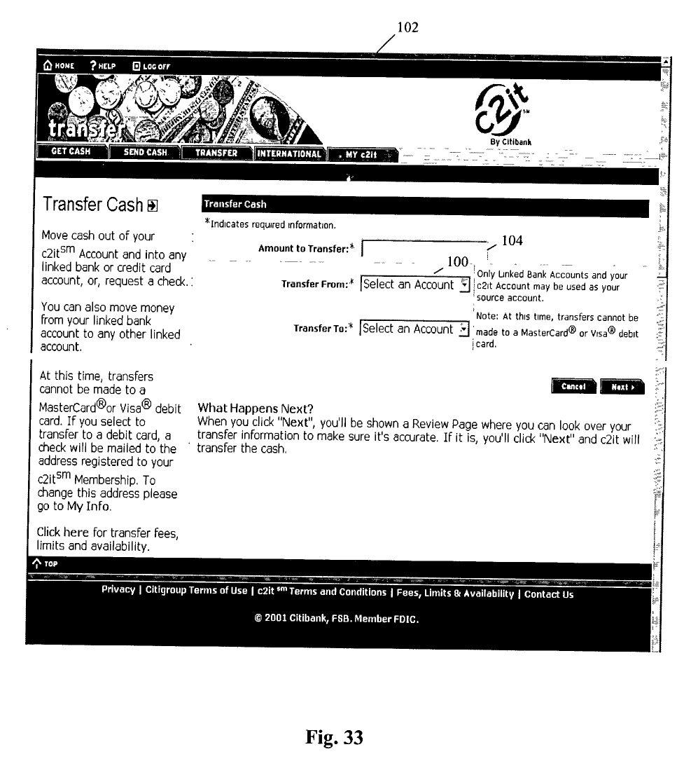

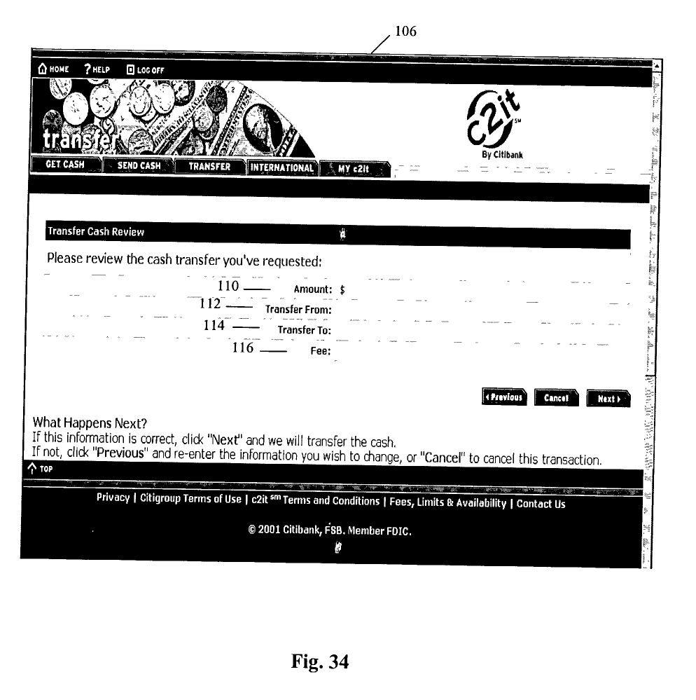

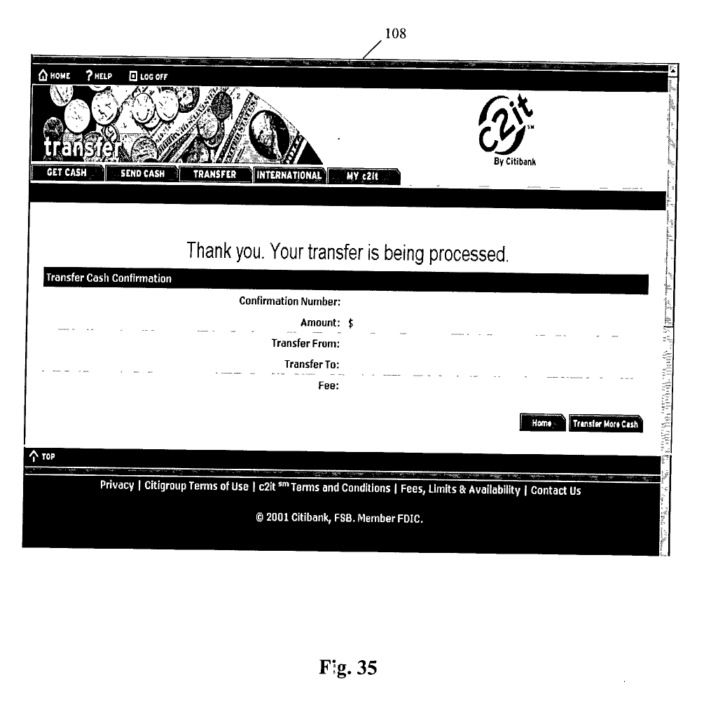

FIG. 31 is a flow chart which illustrates an example of use of a transfer module for the process of moving funds between registered accounts for an embodiment of the present invention. The transfer module is presented, for example, for new and existing customers who wish to move money between registered accounts, such as from one profile account to another profile account, to and from the customer's clip with a “self-fund” look and feel, and/or to pay a credit line. FIG. 32 is a flow chart which shows an example of the process of transferring funds in the system for an embodiment of the present invention. FIGS. 33-35 are sample GUI screens for the process of transferring funds between registered accounts for an embodiment of the present invention. Referring to FIGS. 31-35, at S110, a list of eligible accounts for transfer is displayed for the customer 10 in a drop down box 100 on a transfer cash page 102, and the customer 10 is prompted to select one or more accounts via the drop down box 100 at S111. Alternatively, if called as self-fund, the destination account is automatically the member/s clip 22. When setting the amount, the customer 10 can also enter a selection to make a transaction repeat.

Real time field validation is provided for all required values via Javascript, and all information required for the entire process is submitted at the end of the process. At S113, information collected from the customer 10 and/or generated by the process is displayed on an edit page 106 and a confirm page 108. The information includes, for example, amount of transaction 110, the “from” account 112, the “to” account 114, the fee 116, as well as funds availability, description, display transaction reference number, and repeat, if applicable. At S114, if the customer 10 selects a check box, for example, for “send me a check”, a check is issued only against cash in the customer's clip, rather than against a customer's line of credit. At S115, if the customer 10 does not have an account added to the service, when the self-fund is called, the customer is dynamically served the “add account” module.

At S116, self-fund is called for a person-to-person payment when the customer 10 has an insufficient cash balance in the customer's clip. At S117, if the customer 10 has a line of credit, the line of credit atomically draws the required funds into the cash balance. In addition, at S118, the customer 10 is able to manually invoke the self-fund mode and fund from another source account. If the customer 10 does not have line of credit, the self-fund function is invoked and the customer 10 can source funds from a profiled account. At S119, fees are displayed for the customer 10, as well as funds availability in the customer's clip 22. If there are no fees, including annual fees, a message, such as “FREE” or waived, is displayed for the customer 10. While ACH transfers do not have a delay, self funds from an ACH do have a delay. Therefore, at S120, a message is displayed for the customer 10 detailing the delay when the customer elects to self-fund from an ACH. Transfers cannot be cancelled, but the customer 10 must instead reverse the transaction.

An additional aspect of the present invention is third party integration. A distribution method for the service for an embodiment of the present invention involves the use of a third party as a distributor of the product. In the third party integration aspect, that integration or distribution strategy is continued. However, the strategy is continued in the sense that API's or a specific set of protocols are leveraged, so that the look and feel and branding of the service can be changed, while labeling the service with those third parties or partners.

Various preferred embodiments of the invention have been described in fulfillment of the various objects of the invention. It should be recognized that these embodiments are merely illustrative of the principles of the invention. Numerous modifications and adaptations thereof will be readily apparent to those skilled in the art without departing from the spirit and scope of the present invention.

What is claimed is:

1. A method of performing an on-line transaction, comprising:
arranging pre-qualification of a plurality of customers of a third party on-line service provider for an on-line payments service based on pre-defined parameters established by a financial institution providing the on-line payments service;
receiving customer information about at least one pre-qualified customer from the third party service provider by the financial institution pursuant to an indication of agreement entered by the customer at a terminal in response to a prompt;
allowing the customer at the terminal in response to a prompt to confirm the customer information on a review information page pre-filled with the customer information received from the third party service provider;
allowing the customer at the terminal in response to a prompt to enter information specifically pertaining to a proposed transaction account for the customer and for thereafter accessing the account;
conditionally approving the proposed transaction account for the customer by the financial institution without further verification and with a pre-defined service level and subject to a pre-determined transaction threshold; and
allowing the customer at the terminal to use the conditionally approved transaction account for a transaction according to pre-determined transaction parameters established for the pre-defined service level and subject to the pre-determined transaction threshold.

2. The method of claim 1, wherein arranging the pre-qualification further comprises arranging the pre-qualification of customers of the third party service provider who pay the service provider's charges using a credit card account.

3. The method of claim 2, wherein arranging the pre-qualification further comprises arranging for execution of the pre-qualification by the third party service provider based on the pre-defined parameters provided to the service provider by the financial institution.

4. The method of claim 3, wherein the third party service provider further comprises an Internet Service Provider.

5. The method of claim 3, wherein the on-line payments service is co-branded by the third party service provider and the financial institution.

6. The method of claim 1, wherein receiving the customer information further comprises receiving an entry by the customer at the terminal in response to a prompt of an indication of the customer's agreement to allow the third party service provider to share the customer information with the financial institution.

7. The method of claim 6, wherein receiving the customer information further comprises receiving pre-defined customer information fields for the customer from the third party service provider in response to a request by the financial institution.

8. The method of claim 1, wherein allowing the customer to confirm the customer information further comprises allowing the customer to confirm and update the pre-filled customer information consisting at least in part of the customer's name, address, and telephone number received from the third party service provider.

9. The method of claim 1, wherein allowing the customer to enter information pertaining to the proposed transaction account and for thereafter accessing the account further comprises allowing the customer to enter on an account security page information consisting at least in part of a transaction account password and an indication of the customer's consent relative to an electronic signature.

10. The method of claim 1, further comprising receiving an entry by the customer at the terminal in response to a prompt of an indication of the customer's acceptance of terms, conditions, and legal notifications pertaining to the proposed transaction account.

11. The method of claim 1, further comprising displaying a jump page for the customer at the terminal with information consisting at least in part of a conditional approval of the proposed transaction account and instructions pertaining to linking a source account.

12. The method of claim 1, wherein conditionally approving the proposed transaction account for the customer further comprises employing a customer relations management process to request the customer's Social Security Number and date of birth if the pre-determined transaction threshold is reached.

13. The method of claim 1, wherein allowing the customer to use the conditionally approved transaction account further comprises generating an outbound email message to the customer by a fraud early warning process requesting the customer's Social Security Number and date of birth when the pre-determined transaction threshold is reached.

14. The method of claim 1, wherein allowing the customer to use the conditionally approved transaction account further comprises allowing the customer at the terminal to transfer funds between eligible accounts.

15. The method of claim 14, wherein allowing the customer to transfer the funds further comprises allowing the customer to enter an amount and a selection of an eligible transfer from account and an eligible transfer to account from a drop down box on a transfer cash page.

16. The method of claim 15, wherein allowing the customer to transfer the funds further comprises allowing the customer at the terminal to confirm the customer's entry of the amount and selection of the transfer from and transfer to accounts on a confirm page.

17. The method of claim 1, wherein allowing the customer to use the conditionally approved transaction account further comprises allowing the customer at the terminal to transfer funds via selection of a self-fund mechanism.

18. The method of claim 17, wherein allowing the customer to transfer funds via the self-fund mechanism further comprises prompting the customer at the terminal to enroll a source of funds account, if the self-fund selection is made for the customer without an account enrolled as a source account.

19. The method of claim 18, wherein allowing the customer to transfer funds via the self-fund mechanism further comprises providing the customer at the terminal an instant availability of funds, if the customer enrolls a credit card account verified as the customer's account as the source account.

20. A system for performing an on-line transaction, comprising:
means for arranging pre-qualification of a plurality of customers of a third party on-line service provider for an on-line payments service based on pre-defined parameters established by a financial institution providing the on-line payments service;
means for receiving customer information about at least one pre-qualified customer from the third party service provider by the financial institution pursuant to an indication of agreement entered by the customer at a terminal in response to a prompt;
means for allowing the customer at the terminal in response to a prompt to confirm the customer information on a review information page pre-filled with the customer information received from the third party service provider;
means for allowing the customer at the terminal in response to a prompt to enter information specifically pertaining to a proposed transaction account for the customer and for thereafter accessing the account;
means for conditionally approving the proposed transaction account for the customer by the financial institution without further verification and with a pre-defined service level and subject to a pre-determined transaction threshold; and
means for allowing the customer at the terminal to use the conditionally approved transaction account for a transaction according to pre-determined transaction parameters established for the pre-defined service level and subject to the pre-determined transaction threshold.

21. The system of claim 20, wherein the means for arranging the pre-qualification further comprises means for arranging the pre-qualification of customers of the third party service provider who pay the service provider's charges using a credit card account.

22. The system of claim 21, wherein the means for arranging the pre-qualification further comprises means for arranging for execution of the pre-qualification by the third party service provider based on the pre-defined parameters provided to the service provider by the financial institution.

23. The system of claim 22, wherein the third party service provider further comprises an Internet Service Provider.

24. The system of claim 22, wherein the on-line payments service is co-branded by the third party service provider and the financial institution.

25. The system of claim 20, wherein the means for receiving the customer information further comprises means for receiving an entry by the customer at the terminal in response to a prompt of an indication of the customer's agreement to allow the third party service provider to share the customer information with the financial institution.

26. The system of claim 25, wherein the means for receiving the customer information further comprises means for receiving pre-defined customer information fields for the customer from the third party service provider in response to a request by the financial institution.

27. The system of claim 20, wherein the means for allowing the customer to confirm the customer information further comprises means for allowing the customer to confirm and update the pre-filled customer information consisting at least in part of the customer's name, address, and telephone number received from the third party service provider.

28. The system of claim 20, wherein the means for allowing the customer to enter information pertaining to the proposed transaction account and for thereafter accessing the account further comprises means for allowing the customer to enter on an account security page information consisting at least in part of a transaction account password and an indication of the customer's consent relative to an electronic signature.

29. The system of claim 20, further comprising receiving an entry by the customer at the terminal in response to a prompt of an indication of the customer's acceptance of terms, conditions, and legal notifications pertaining to the proposed transaction account.

30. The system of claim 20, further comprising displaying a jump page for the customer at the terminal with information consisting at least in part of a conditional approval of the proposed transaction account and instructions pertaining to linking a source account.

31. The system of claim 20, wherein the means for conditionally approving the proposed transaction account for the customer further comprises means for employing a customer relations management process to request the customer's Social Security Number and date of birth if the pre-determined transaction threshold is reached.

32. The system of claim 20, wherein the means for allowing the customer to use the conditionally approved transaction account further comprises means for generating an outbound email message to the customer by a fraud early warning process requesting the customer's Social Security Number and date of birth when the pre-determined transaction threshold is reached.

33. The system of claim 20, wherein the means for allowing the customer to use the conditionally approved transaction account further comprises means for allowing the customer at the terminal to transfer funds between eligible accounts.

34. The system of claim 33, wherein the means for allowing the customer to transfer the funds further comprises means for allowing the customer to enter an amount and a selection of an eligible transfer from account and an eligible transfer to account from a drop down box on a transfer cash page.

35. The system of claim 34, wherein the means for allowing the customer to transfer the funds further comprises means for allowing the customer at the terminal to confirm the customer's entry of the amount and selection of the transfer from and transfer to accounts on a confirm page.

36. The system of claim 20, wherein the means for allowing the customer to use the conditionally approved transaction account further comprises means for allowing the customer at the terminal to transfer funds via selection of a self-fund mechanism.

37. The system of claim 36, wherein allowing the customer to transfer funds via the self-fund mechanism further comprises means for prompting the customer at the terminal to enroll a source of funds account, if the self-fund selection is made for the customer without an account enrolled as a source account.

38. The system of claim 37, wherein allowing the customer to transfer funds via the self-fund mechanism further comprises means for providing the customer at the terminal an instant availability of funds, if the customer enrolls a credit card account verified as the customer's account as the source account.
